(19) United States
(12) Patent Application Publication
(10) Pub. No.: US 2026/0278489 A1
(43) Pub. Date: Sep. 17, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventor: Yasutaka IINUMA, Tokyo (JP)

(73) Assignee: NEC Corporation, Tokyo (JP)

(21) Appl. No.: 19/168,451

(22) PCT Filed: Mar. 15, 2024
(86) PCT No.: PCT/JP2024/010306

§ 371 Date: Sep. 24, 2025

(30) Foreign Application Priority Data
Mar. 31, 2023 (JP) 2023-059160

(51) Int. Cl. G06Q 10/0631; G06Q 10/04; G06Q 50/06; G06Q 50/40

(52) U.S. Cl. CPC G06Q 10/06311; G06Q 10/04; G06Q 50/06; G06Q 50/40

(57) ABSTRACT

This charging plan creating system comprises: prediction models that are generated for each vehicle type of a plurality of electric vehicles used in an airport, the prediction models accepting input of information including work content of the electric vehicles and outputting a predicted power consumption amount of the electric vehicles; an acquiring unit which acquires a current operation schedule including the work content for each of the plurality of electric vehicles; and a plan creating unit which inputs the work content specified on the basis of the operation schedules of the plurality of electric vehicles into the prediction models corresponding to the respective vehicle types of the electric vehicles, and uses an output of a first model to create a charging plan for the plurality of electric vehicles, the charging plan including a charge start timing and information relating to a power supply, for each electric vehicle.

### TECHNICAL FIELD

The present invention relates to a charging plan creating system, an information processing device, an information processing method, and a program.

### BACKGROUND ART

PTL 1 discloses an energy management apparatus including: an acquisition unit that acquires a remaining amount of a storage battery mounted on an aircraft on the assumption that electrification of business vehicles at an airport proceeds for global warming countermeasures, and a plan creation unit that creates a power usage plan, which is a power usage plan of airport facilities, which are facilities at the airport, by using the remaining amount of the storage battery.

In addition, PTL 2 discloses an example of a charging management system that suppresses a charging congestion of electric vehicles in an airport as a technology for managing charging timings of a plurality of electric vehicles working in the airport. The system described in PTL 2 includes a collection unit that collects arrival-departure information and information regarding a cargo amount of an arrival-departure flight, a planning unit that creates a work plan of an electric vehicle that works at an airport based on the information collected by the collection unit, and a determination unit that determines a charging timing of each electric vehicle based on the work plan created by the planning unit. The charging timing of each electric vehicle is determined in consideration of a work period, a distance between a charging station and a work area for working during the work period in each electric vehicle, and a battery capacity of each electric vehicle.

### CITATION LIST

### Patent Literature

PTL 1: JP 2022-45029 A
PTL 2: JP 2021-12566 A

### SUMMARY OF INVENTION

### Technical Problem

However, the technique disclosed in the above-described PTLs makes a work plan for the electric vehicle that works at the airport based on a cargo amount of arrivals and departures of the aircraft, and determines the charging timing of each electric vehicle based on the work plan. Therefore, in the technology disclosed in the above-described PTLs, there has been a problem in that it is not possible to propose a charging timing that is adapted to the current situation, which may differ from the plan, such as a case where the aircraft arrival-departure time is suddenly changed or the electric vehicle cannot be charged at the instructed charging timing is not assumed.

In view of the above-described problems, an object of the present invention is to provide a charging plan creating system, an information processing device, an information processing method, and a program that solve a problem that it was difficult to appropriately determine a charging timing of various electric vehicles working at an airport in accordance with a current situation.

### Solution to Problem

According to one aspect of the present invention, there is provided an information processing device including:
a first model generated for each vehicle type of a plurality of electric vehicles used at an airport, the first model that receives, as an input, information including a work content of the electric vehicle and outputs a predicted power consumption of the electric vehicle;
acquisition means for acquiring a current task schedule including work content of each of the plurality of electric vehicles; and
plan creation means for inputting work contents specified based on the task schedules of the plurality of electric vehicles to the first models associated with vehicle types of the electric vehicles, and creating a charging plan of the plurality of electric vehicles using the output of the first models, the charging plan including information regarding a charging start timing and a power feeder for each of the electric vehicles.

According to another aspect of the present invention, there is provided a charging plan creating system including:
a user terminal of a user using a plurality of electric vehicles used at an airport;
an information processing device, in which
the information processing device includes:
a first model generated for each vehicle type of a plurality of electric vehicles used at an airport, the first model that receives, as an input, information including a work content of the electric vehicle and outputs a predicted power consumption of the electric vehicle for each vehicle type of the plurality of electric vehicles;
acquisition means for acquiring a current task schedule including work content of each of the plurality of electric vehicles;
plan creation means for inputting work contents specified based on the task schedules of the plurality of electric vehicles to the first models associated with vehicle types of the electric vehicles, and creating a charging plan of the plurality of electric vehicles using the output of the first models, the charging plan including information regarding a charging start timing and a power feeder for each of the electric vehicles; and
provision means for providing information regarding the charging plan to the user terminal.

According to still another aspect of the present invention, there is provided an information processing method in which one or more computers include:
a first model generated for each vehicle type of a plurality of electric vehicles used at an airport, the first model that receives, as an input, information including a work content of the electric vehicle and outputs a predicted power consumption of the electric vehicle, in which
the one or more computers
acquire a current task schedule including work content of each of the plurality of electric vehicles; and
input work contents specified based on the task schedules of the plurality of electric vehicles to the first models associated with vehicle types of the electric vehicles, and create a charging plan of the plurality of electric vehicles using the output of the first models, the charging plan including information regarding a charging start timing and a power feeder for each of the electric vehicles.

According to further aspect of the present invention, there is provided a program in which a computer includes a first model generated for each vehicle type of a plurality of electric vehicles used at an airport, the first model that receives, as an input, information including a work content of the electric vehicle and outputs a predicted power consumption of the electric vehicle,
the program causing the computer to execute:
acquisition processing for acquiring a current task schedule including work content of each of the plurality of electric vehicles; and
plan creation processing for inputting work contents specified based on the task schedules of the plurality of electric vehicles to the first models associated with vehicle types of the electric vehicles, and creating a charging plan of the plurality of electric vehicles using the output of the first models, the charging plan including information regarding a charging start timing and a power feeder for each of the electric vehicles.

As another aspect of the present invention, a program that causes at least one or more computers to execute the method of the above aspect may be used, or a computer-readable recording medium storing such a program may be used. The recording medium includes a non-transitory tangible medium.

The computer program includes a computer program code that, upon being executed by a computer, causes the computer to perform the information processing method on an information processing device.

Any combinations of the above components and modifications of the expressions of the present invention in methods, apparatuses, systems, recording media, computer programs, and the like are also effective as aspects of the present invention.

The various components of the present invention do not necessarily have to be independent from each other, and a plurality of components may be formed as one member, one component may be formed of a plurality of members, a certain component may be a part of another component, a part of a certain component may overlap with a part of another component, and the like.

In the method and the computer program of the present invention, a plurality of procedures is described in order, but the described order does not limit the order of executing the plurality of procedures. Therefore, in a case where the method and the computer program of the present invention are implemented, the order of the plurality of procedures can be changed within a range in which there is no problem in content.

The plurality of procedures of the method and computer program of the present invention are not limited to being executed at individually different timings. Therefore, another procedure may occur during the execution of a certain procedure, the execution timing of a certain procedure may partially or entirely overlap with the execution timing of another procedure, or the like.

### Advantageous Effects of Invention

According to one aspect of the present invention, it is possible to obtain a charging plan creating system, an information processing device, an information processing method, and a program capable of appropriately determining a charging timing of a wide variety of electric vehicles working at an airport in accordance with a current situation.

### BRIEF DESCRIPTION OF DRAWINGS

FIG. 1 It is a diagram illustrating an outline of an information processing device according to an example embodiment.

FIG. 2 It is a flowchart illustrating an operation example of the information processing device according to the example embodiment.

FIG. 3 It is a diagram conceptually illustrating a system configuration of a charging plan creating system according to an example embodiment.

FIG. 4 It is a diagram illustrating an outline of a charging plan creating system according to an example embodiment.

FIG. 5 It is a block diagram illustrating a hardware configuration of a computer that implements an information processing device.

FIG. 6 It is a functional block diagram illustrating a logical configuration example of an information processing device according to an example embodiment.

FIG. 7 It is a diagram illustrating an example of a data structure of work schedule information.

FIG. 8 It is a diagram illustrating an example of a data structure of user information.

FIG. 9 It is a diagram illustrating an example of a notification screen displayed on a display of a user terminal.

FIG. 10 It is a diagram illustrating an example of a data structure of flight information.

FIG. 11 It is a diagram illustrating an example of a data structure of aircraft information.

FIG. 12 It is a flowchart illustrating an operation example of the information processing device according to the example embodiment.

FIG. 13 It is a functional block diagram illustrating a logical configuration example of an information processing device according to the example embodiment.

FIG. 14 It is a diagram illustrating an example of a data structure of vehicle information.

FIG. 15 It is a diagram illustrating an example of a data structure of vehicle battery information.

FIG. 16 It is a diagram illustrating an example of a data structure of vehicle-specific charging history information.

FIG. 17 It is a diagram illustrating an example of a data structure of power feeder information.

FIG. 18 It is a diagram illustrating an example of a data structure of power feeder-specific power feeding history information.

FIG. 19 It is a diagram showing an example of a data structure of electric power consumption prediction information.

FIG. 20 It is a diagram illustrating an example of a data structure of power feeder usage prediction information.

FIG. 21 It is a flowchart illustrating an operation example of the information processing device according to the example embodiment.

FIG. 22 It is a diagram illustrating an example of a predicted usage status screen of a power feeder.

FIG. 23 It is a diagram illustrating an example of a detail screen of a predicted usage status of the power feeder.

FIG. 24 It is a diagram illustrating an example of a predicted usage status screen in a map format.

FIG. 25 It is a diagram conceptually illustrating a system configuration of a charging plan creating system according to an example embodiment.

FIG. 26 It is a functional block diagram illustrating a logical configuration example of an information processing device according to an example embodiment.

FIG. 27 It is a diagram illustrating parameter information and an optimization model used for optimization.

FIG. 28 It is a diagram illustrating parameter information and an optimization model used for optimization.

FIG. 29 It is a diagram illustrating an example of a data structure of recommendation information.

FIG. 30 It is a diagram illustrating an example of a charging plan screen.

FIG. 31 It is a flowchart illustrating a detailed procedure of charging plan creation processing.

FIG. 32 It is a diagram conceptually illustrating a system configuration of a charging plan creating system according to an example embodiment.

FIG. 33 It is a diagram illustrating an example of a data structure of vehicle-specific work situation information.

FIG. 34 It is a diagram illustrating an example of a data structure of work history information.

FIG. 35 It is a diagram illustrating an example of a reservation screen.

FIG. 36 It is a diagram illustrating an example of a data structure of power feeder-specific power feeding reservation information.

### EXAMPLE EMBODIMENT

Hereinafter, example embodiments of the present invention will be described with reference to the drawings. In all the drawings, the same components are denoted by the same reference numerals, and the description thereof is omitted as appropriate. In each of the following drawings, a configuration of a portion not involved in the essence of the present invention is omitted and not illustrated.

In the example embodiment, the “acquisition” includes at least one of an own device going to obtain data or information stored in another device or a storage medium (active acquisition) and an own device receiving data or information output from another device (passive acquisition). Examples of the active acquisition include requesting or inquiring another device and receiving a reply thereto and accessing and reading another device or a storage medium. Examples of passive acquisition include reception of information to be distributed (alternatively, transmission, push notification, and the like). Further, “acquisition” may be selecting and acquiring from among received data or information or selecting and receiving distributed data or information.

### Minimum Configuration Example

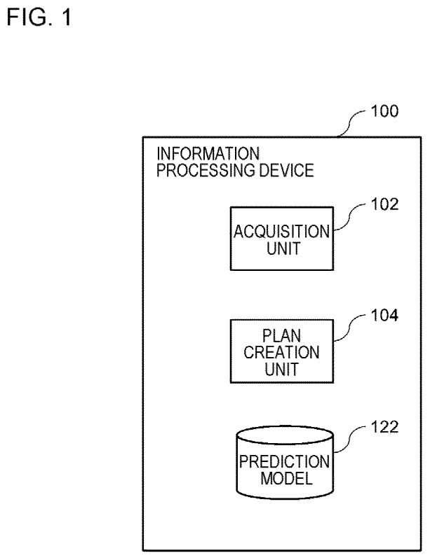

FIG. 1 is a diagram illustrating an outline of an information processing device 100 according to an example embodiment. The information processing device 100 includes an acquisition unit 102, a plan creation unit 104, and a prediction model 122.

The prediction model 122 (first model) is a model generated for each vehicle type of a plurality of electric vehicles 50 used at an airport, and receives, as an input, information including work content of the electric vehicle 50 and outputs predicted power consumption of the electric vehicle 50.

The acquisition unit 102 acquires a current task schedule including the work content of each of the plurality of electric vehicles 50.

The plan creation unit 104 inputs the work content specified based on the task schedules of the plurality of electric vehicles 50 to the prediction model 122 (first model) associated with the vehicle type of each electric vehicle 50, and creates a charging plan of the plurality of electric vehicles 50 including a charging start timing for each electric vehicle 50 and information regarding a power feeder 20 by using the output of the prediction model 122.

### Operation Example

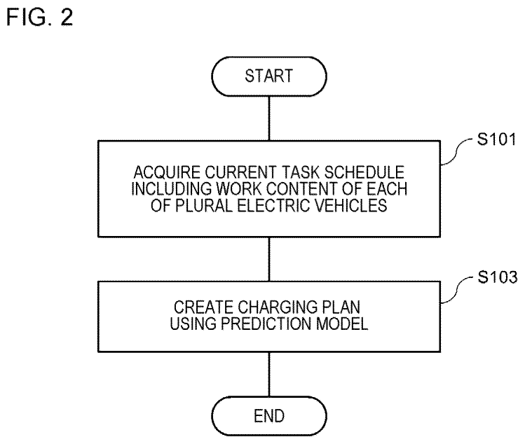

FIG. 2 is a flowchart illustrating an operation example of the information processing device 100 according to the example embodiment.

The acquisition unit 102 acquires the current task schedule including the work content of each of the plurality of electric vehicles 50 (step S101).

The plan creation unit 104 inputs the work content specified based on the task schedules of the plurality of electric vehicles 50 to the prediction model 122 (first model) associated with the vehicle type of each electric vehicle 50, and creates a charging plan of the plurality of electric vehicles 50 including a charging start timing for each electric vehicle 50 and information regarding a power feeder 20 by using the output of the prediction model 122 (step S103).

According to the information processing device 100, it is possible to solve a problem that it is difficult to appropriately determine the charging timing of the electric vehicle working at the airport in accordance with the current situation.

Hereinafter, a detailed example of the information processing device 100 will be described.

### FIRST EXAMPLE EMBODIMENT

### System Overview

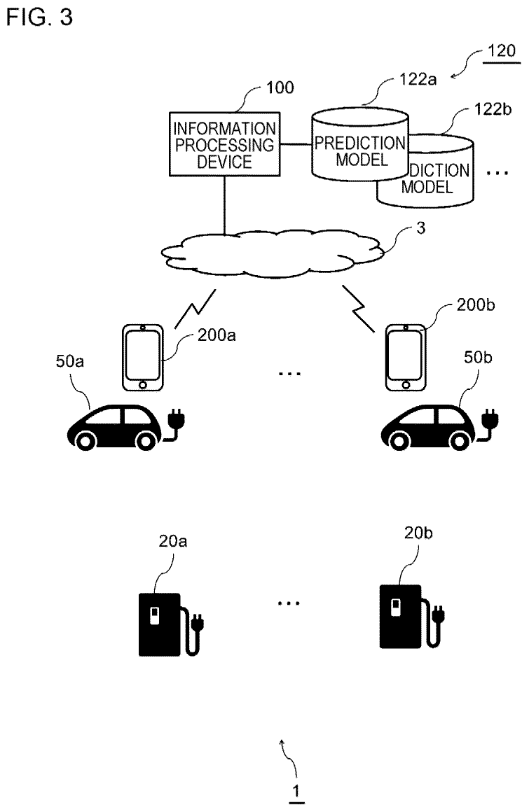

FIG. 3 is a diagram conceptually illustrating a system configuration of the charging plan creating system 1 according to the example embodiment.

The charging plan creating system 1 includes an information processing device 100 and user terminals 200a, 200b, . . . (hereinafter, referred to as user terminals 200 in a case where there is no particular need to distinguish them) used by users of a plurality of electric vehicles 50a, 50b, . . . (the number of the electric vehicles is not limited, hereinafter, in a case where there is no particular need to distinguish them, hereinafter referred to as electric vehicles 50). The information processing device 100 is connected to the user terminal 200 via a communication network 3.

The information processing device 100 is a computer such as a server computer. The user terminal 200 is a computer such as a smartphone, a tablet terminal, or a personal computer. Alternatively, the user terminal 200 may be a computer that implements a navigation device or the like mounted on the electric vehicle 50. The user terminal 200 is a terminal used by at least one of a worker or a manager thereof who performs work using the electric vehicle 50 and a driver of the electric vehicle 50. Hereinafter, a worker who uses the user terminal 200 or a manager thereof is referred to as a “user”.

The information processing device 100 includes a storage device 120. The storage device 120 may be provided inside the information processing device 100 or may be provided outside. That is, the storage device 120 may be hardware integrated with the information processing device 100 or may be hardware separate from the information processing device 100.

The storage device 120 includes a prediction model 122 (in the drawing, the prediction model 122a, the prediction models 122b, . . . are illustrated, but the number is not limited; in addition, in a case where there is no particular need to distinguish, the prediction model is illustrated as prediction models 122) generated for each of the plurality of electric vehicles 50.

In airports, various tasks for flying airplanes (for example, loading of luggage, refueling, transportation and getting on and off of an occupant and a passenger, simple inspection and maintenance, and the like) are performed. A vehicle for business use is used for these tasks. A place where these tasks are performed is called an apron. In a case where the business vehicle is an electric vehicle, the electric vehicle 50 can receive power feeding from a power feeder 20 (in the drawing, the power feeder 20a, the power feeders 20b, . . . are illustrated, but the number thereof is not limited; further, in a case where there is no particular need to distinguish, the power feeder 20 is illustrated) installed in the apron.

The electric vehicle 50 uses electricity as at least a part of a power source. The electric vehicle 50 according to the example embodiment is either an electric vehicle (EV) or a plug-in hybrid vehicle (PHV). However, the electric vehicle 50 may be a fuel cell vehicle (FCV). In the case of a fuel cell vehicle, the electric vehicle 50 is supplied with fuel (hydrogen) at a hydrogen station instead of the power feeder 20 described later.

The electric vehicle 50 includes a storage battery (not illustrated) that stores electricity of a power source, and the storage battery can be charged using the power feeder 20. The place where the power feeder 20 is installed is also called a “station”.

The electric vehicle 50 is a vehicle that performs various works at an airport. The electric vehicle 50 includes, for example, at least one of a towing tractor that tows an aircraft, a tractor that connects a dolly carrying a container, a catering car that mounts interior goods on the aircraft, a high lift loader that loads a cargo container into a cargo compartment, a belt loader that mounts a passenger's cargo in the cargo compartment, a water supply vehicle that supplies water to the aircraft, and the like. However, the electric vehicle 50 is not limited thereto.

The power feeder 20 is electrically connected to the electric vehicle 50 to charge a storage battery of the electric vehicle 50. Depending on the amount of charge required by the storage battery of the electric vehicle 50, power feeding requires, for example, tens of minutes to several hours per one electric vehicle 50. Therefore, if a large number of electric vehicles 50 visit the station at a time to perform charging, the station becomes congested and the waiting time becomes long, resulting in poor efficiency.

The work in the apron is performed for each work or by a company commissioned for each airline. However, since information on the work of each company is not shared, it was difficult to grasp all the task schedules of each company. In addition, the work form of the worker who performs work at the airport is a shift system, and the charging timing tends to be concentrated in a time slot in which the worker changes. Furthermore, since the task schedule is assembled around the flight schedule, the business time of the electric vehicle 50 overlaps before and after the arrival and departure of the aircraft, and thus the power feeding demand of the electric vehicle 50 tends to concentrate at the same time. Further, since flights are often delayed due to weather or various factors, the flight schedule is often suddenly changed. Accordingly, the task schedule is also suddenly changed.

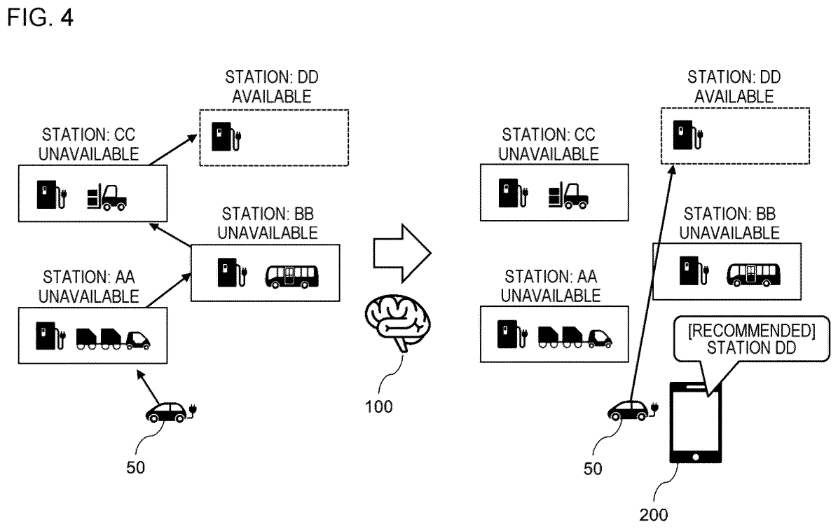

Therefore, in a case where the charging plan creating system 1 is not used, as illustrated in a left diagram of FIG. 4, in a case where the electric vehicle 50 needs to be charged, the electric vehicle stops by nearby charging stations AA, BB, and CC in order, and can be charged at a last station D. Alternatively, at a station that another electric vehicle 50 is already charging, the electric vehicle 50 needs to wait at the station until the charging of the other electric vehicle 50 is completed.

On the other hand, the charging plan creating system 1 determines an optimal charging timing and a charging place for each electric vehicle 50 using the prediction model 122 machine-learned for each electric vehicle 50 by the information processing device 100, and provides information to the user terminal 200 of the user of the electric vehicle 50. Therefore, as illustrated in the right diagram of FIG. 4, the electric vehicle 50 can go straight to the recommended charging station DD without going around other stations and can be charged without waiting.

### Hardware Configuration Example

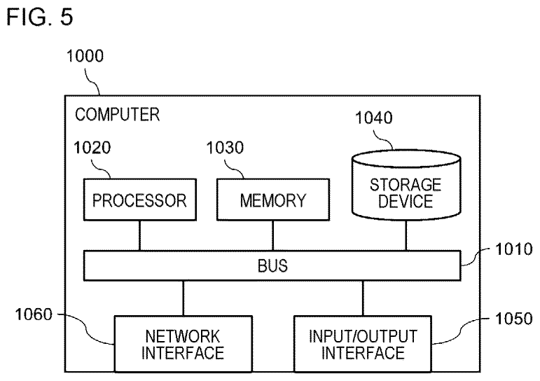

FIG. 5 is a block diagram illustrating a hardware configuration of a computer 1000 that implements the information processing device 100. The user terminal 200 in FIG. 3 is also achieved by the computer 1000. Alternatively, a control device (not illustrated) and a navigation device (not illustrated) mounted on the electric vehicle 50 of FIG. 3 are also achieved by the computer 1000.

The computer 1000 includes a bus 1010, the processor 1020, the memory 1030, the storage device 1040, an input/output interface 1050, and a network interface 1060.

The bus 1010 is a data transmission path for the processor 1020, the memory 1030, the storage device 1040, the input/output interface 1050, and the network interface 1060 to transmit and receive data to and from each other. However, the method of connecting the processor 1020 and the like to each other is not limited to the bus connection.

The processor 1020 is a processor implemented by a central processing unit (CPU), a graphics processing unit (GPU), or the like.

The memory 1030 is a main storage device implemented by a random access memory (RAM) or the like.

The storage device 1040 is an auxiliary storage device implemented by a hard disk drive (HDD), a solid state drive (SSD), a memory card, a read only memory (ROM), or the like. The storage device 1040 stores a program module that achieves each function (for example, the acquisition unit 102, the plan creation unit 104, a model generation unit 112, a provision unit 106, and the like, which will be described later) of the information processing device 100. The processor 1020 achieves the functions associated to the program modules by reading and executing the program modules on the memory 1030. In addition, the storage device 1040 may also store each data of the storage device 120.

The program module may be recorded in a recording medium. The recording medium that records the program module includes a non-transitory tangible medium that can be used by the computer 1000, and a program code readable by the computer 1000 (processor 1020) may be embedded in the medium.

The input/output interface 1050 is an interface that connects the computer 1000 and various input/output devices. The input/output interface 1050 also functions as a communication interface that performs near field radio communication such as Bluetooth (registered trademark) or near field communication (NFC).

The network interface 1060 is an interface for connecting the computer 1000 to the communication network 3. The communication network 3 is, for example, a local area network (LAN) or a wide area network (WAN). A method of connecting the network interface 1060 to the communication network 3 may be wireless connection or wired connection.

Then, the computer 1000 is connected to a necessary device (for example, an operation unit such as an operation key, a keyboard, a mouse, or a touch panel, a display, a speaker, a microphone, or a camera, or the like) via the input/output interface 1050 or the network interface 1060. The display is, for example, a liquid crystal display, an organic electro-luminescence (EL) display, or the like, and is not particularly limited.

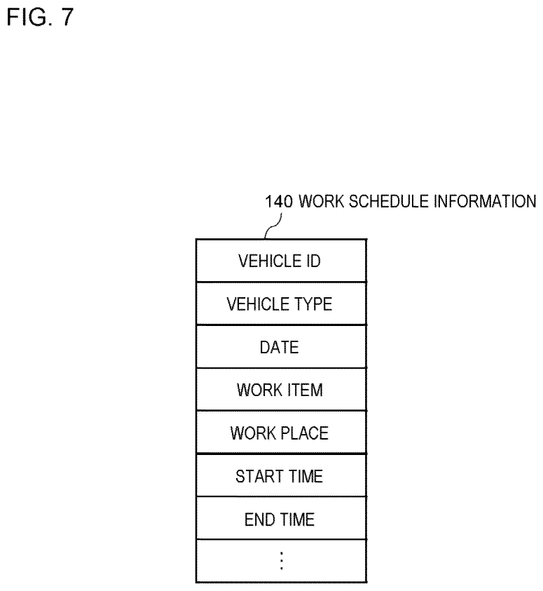

Each component of the information processing device 100 of each example embodiment in FIG. 1 and FIG. 7 to be described later is achieved by any combination of hardware and software of the computer 1000 in FIG. 5. Those skilled in the art will understand that there are various modifications of the implementation method and device. The functional block diagram illustrating the information processing device 100 of each example embodiment illustrates a logical functional unit block instead of a hardware unit configuration.

### Functional Configuration Example

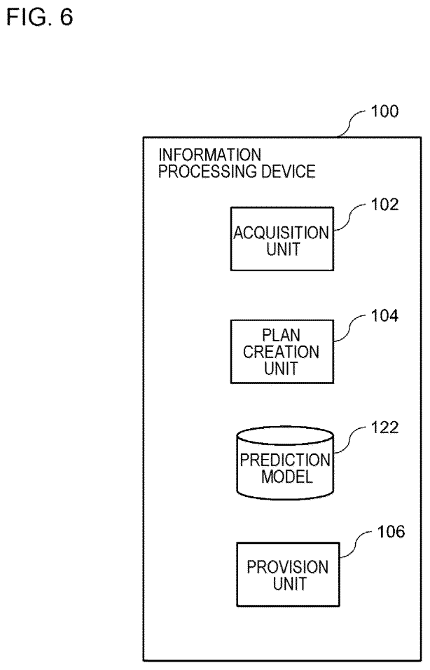

FIG. 6 is a functional block diagram illustrating a logical configuration example of the information processing device 100 according to the example embodiment.

The information processing device 100 according to the example embodiment further includes a provision unit 106 in addition to the configuration of the information processing device 100 in FIG. 1. However, the provision unit 106 may be achieved by a computer other than the information processing device 100, for example, a web server or the like.

The prediction model 122 (first model) is a model generated for each vehicle type of a plurality of electric vehicles 50 used at an airport, and receives, as an input, information including work content of the electric vehicle 50 and outputs predicted power consumption of the electric vehicle 50.

The acquisition unit 102 acquires the current task schedule including the work content of each of the plurality of electric vehicles 50, and stores the acquired current task schedule in the storage device 120 as the work schedule information 140. The information regarding the task schedule may be acquired in a predetermined format file (for example, The Internet Calendaring and Scheduling Core Object Specification (iCalendar) format, Calendaring Extensions to Web-based Distributed Authoring and Versioning (WebDAV) (CalDAV) format, Comma Separated Values (CSV) format, and the like) from the schedule program of the computer of each of the management companies. Alternatively, the task schedule of each worker (electric vehicle) may be input on a task schedule input screen on a predetermined page of a website provided by the charging plan creating system 1 by an input operation of a person in charge or a worker who performs the operation. These input operations can be performed using, for example, a computer such as a personal computer (not illustrated) of each management company or a mobile terminal used by the worker. The information processing device 100 may acquire the task schedule input to the charging plan creating system 1 using these computers. Alternatively, the information processing device 100 may receive an input of information regarding the task schedule on my page or the like displayed by login in a predetermined application installed on the user terminal 200 described later or a predetermined website browsed on the user terminal 200.

FIG. 7 is a diagram illustrating an example of a data structure of the work schedule information 140. The work schedule information 140 includes, for each electric vehicle 50, information indicating a vehicle type, information indicating a date, information indicating a work item for each work, information indicating a work place, and information indicating a start time and an end time of the work. However, the work end time included in the work schedule information 140 may be information indicating a work time instead. That is, the work end time may be calculated from the work start time and the time for performing the work from the start time. In a case where the work item is determined depending on the vehicle type, the work item may not be included in the work schedule information 140.

The plan creation unit 104 inputs the work content specified based on the task schedules of the plurality of electric vehicles 50 to the prediction model 122 (first model) associated with the vehicle type of each electric vehicle 50. Then, the plan creation unit 104 creates a charging plan of the plurality of electric vehicles 50 including the charging start timing for each electric vehicle 50 and information regarding the power feeder 20 (for example, position information on the power feeder 20) by using the output of the prediction model 122.

As described above, the work content includes the work start time and the work end time.

The plan creation unit 104 creates the charging plan using at least one of the work start time and the work end time associated with the output for each electric vehicle 50 from the prediction model 122.

For example, the plan creation unit 104 estimates a variation (decrease) in the amount of charge based on the predicted value of the power consumption amount based on the work content of the day of each electric vehicle 50 output from the prediction model 122. Then, the plan creation unit 104 specifies a time other than the working time from a predetermined time (for example, one hour before) before a time at which the estimated remaining capacity of the storage battery becomes less than a first threshold (for example, 40% of the battery capacity) to a time at which the estimated remaining capacity of the storage battery becomes less than a second threshold (for example, 30% of the battery capacity). Then, the plan creation unit 104 determines the charging start time in such a way that the charging time (for example, the charging time may be 40 minutes or the like.) is included in a time other than the specified work time.

As described above, the work content includes the work place for each electric vehicle 50.

The plan creation unit 104 creates a charging plan further using a work place associated with the output of the prediction model 122 for each electric vehicle 50.

For example, the plan creation unit 104 determines the power feeder 20 based on the time other than the specified work time, the position information on the work place of the electric vehicle 50 before and after the time, and the position information on the power feeder 20. That is, the plan creation unit 104 preferentially determines, from among the plurality of power feeders 20, the power feeder 20 close to the work place where the electric vehicle 50 performs work before the charging start time or after the charging end time as the charging place.

The provision unit 106 provides the user terminal 200 with information regarding the charging plan.

In order to receive the provision of the information regarding the charging plan via the user terminal 200, the users of the electric vehicle 50 and the user terminal 200 make at least one of the following preparations in advance.
(1) A predetermined application is installed and activated in the user terminal 200.
(2) The user terminal 200 accesses a predetermined website using a browser or the like.
(3) In a case where the user terminal 200 is included in a navigation device of the electric vehicle 50, a predetermined application is downloaded and activated in the navigation device.

The predetermined application and the predetermined website are an application and a website for receiving a service provided by the charging plan creating system 1. Therefore, after the above items (1) to (3), the users of the electric vehicle 50 and the user terminal 200 further perform the following work at least at the time of first use.
(4) The user acquires the account information by registering the account information including the identification information and the authentication information (for example, a password, biometric authentication information, or the like) of the user using the user terminal 200. Then, the user terminal 200 is used to input the account information to log in to the charging plan creating system 1.

Furthermore, in the user registration, in order to further associate the electric vehicle 50 used by the user with the account information, the information processing device 100 accepts registration of identification information on the electric vehicle 50. That is, the information processing device 100 receives the identification information on the electric vehicle 50 for notifying the user terminal 200 of the charging timing, and stores the identification information in the storage device 120 as the user information 180 in association with the account information.

However, it is also assumed that one user uses a plurality of electric vehicles 50, and the electric vehicle 50 to be used changes depending on the task schedule. Therefore, association between the user and the electric vehicle 50 may not be performed at the time of user registration. For example, the acquisition unit 102 may associate the user (user ID) and the electric vehicle 50 (vehicle ID) with information indicating the use time according to the acquired task schedule, and store the associated information in the storage device 120 as second user information (not illustrated).

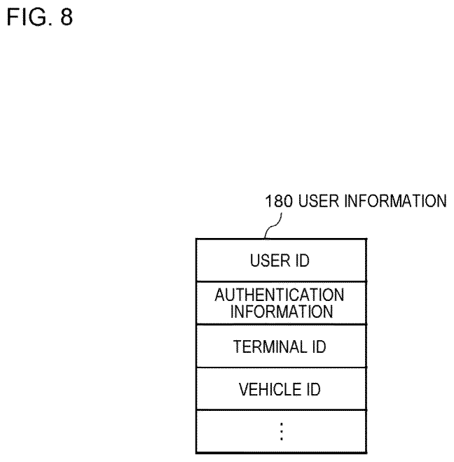

FIG. 8 is a diagram illustrating an exemplary data structure of the user information 180. The user information 180 is associated with identification information (hereinafter, indicated as a user ID) that can identify the user for each user, authentication information, identification information (hereinafter, indicated as a terminal ID) that can identify the user terminal 200, and identification information (hereinafter, indicated as a vehicle ID) that can identify the electric vehicle 50. The user information 180 is stored in the storage device 120, the memory 1030 of the computer 1000, or the storage device 1040. Various types of information described below may be similarly stored in the storage device 120, the memory 1030 of the computer 1000, or the storage device 1040. In the following description, it is described as “stored in the storage device 120”, but this description means that “is stored in the storage device 120 or the memory 1030 or the storage device 1040 of the computer 1000”.

The identification information on the user terminal 200 is not particularly limited as long as it is information capable of identifying the user terminal 200, and is, for example, a telephone number of a mobile phone, a mail address receivable by the terminal, or the like.

The identification information on the electric vehicle 50 is not particularly limited as long as it is information capable of identifying the electric vehicle 50, but may be a registration number of the vehicle or identification information uniquely assigned.

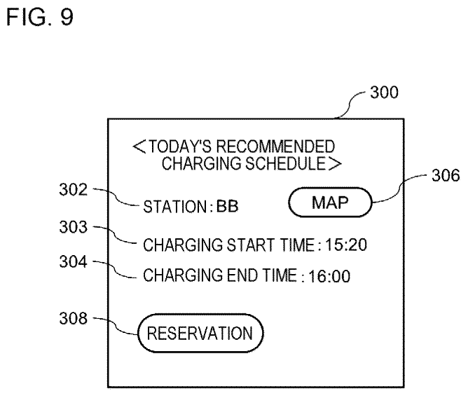

FIG. 9 is a diagram illustrating an example of a notification screen 300 displayed on the display of the user terminal 200. In the case of the application, the notification screen 300 may be popped up on the display of the user terminal 200 in the form of push notification, for example, or may be displayed on the top page of the application. In the case of a website, the notification screen 300 may be displayed, for example, on a front page displayed after login. In both the case of the application and the case of the web site, a notification indicating that there is a new notification may be displayed on the top page, and the notification screen 300 may be displayed on a page for browsing the notification.

The notification screen 300 includes information indicating a recommended charging timing generated based on the task schedule of the electric vehicle 50. The notification screen 300 includes a power feeder display field 302, a charging start time display field 303, a charging end time display field 304, a map display button 306, and a reservation button 308.

In the power feeder display field 302, the name of the power feeder 20 at the recommended position is displayed. In the charging start time display field 303, a recommended time to start charging is displayed. In the charging end time display field 304, a scheduled charging end time in a case where charging is started at the recommended charging start time is displayed. The map display button 306 is a graphical user interface (GUI) that receives a user operation of displaying a map indicating a recommended position of the power feeder 20. The reservation button 308 is a GUI that receives a user operation instructing execution of reservation with the content of the recommended charging schedule.

In a case of receiving the pressing of the map display button 306, the provision unit 106 causes the user terminal 200 to display a screen including a map indicating a recommended position of the station BB of the power feeder 20 in this example. The map may include not only the position of the station BB but also the position of the electric vehicle 50. Further, the map may include information indicating a route from the position of the electric vehicle 50 to the recommended position of the power feeder 20. Further, the map may navigate a route from the location of the electric vehicle 50 to the recommended location of the power feeder 20.

Further, after making a charging reservation, at a predetermined time before the charging start time (for example, 5 minutes before), the provision unit 106 may notify that it is soon the charging start time, and display the notification screen 300 as information indicating a reserved charging schedule.

Furthermore, the work content acquired by the acquisition unit 102 and used by the plan creation unit 104 to create the charging plan further includes flight information 150 of an airplane to be worked by the electric vehicle 50.

The flight information 150 further includes information on an airline that operates the airplane.

The work content may include the aircraft information 152.

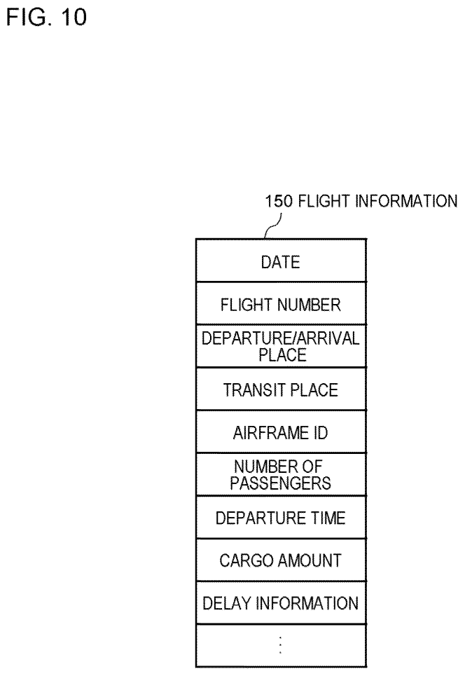

FIG. 10 is a diagram illustrating an example of a data structure of the flight information 150. The flight information 150 can be acquired from a server (not illustrated) of each airline and is stored in the storage device 120. The flight information 150 includes information scheduled in advance and information that is changed as needed in a case where there is a change in the flight. The flight information 150 includes information indicating a date of the scheduled flight, for each flight, a flight number, information indicating a departure place or an arrival place, information indicating a transit place, identification information (hereinafter, indicated as an airframe ID) capable of specifying an aircraft, the number of passengers, a departure time, and a cargo amount. Further, the flight information 150 may include information regarding a delay in a case where the flight is delayed. The information regarding the delay may be stored separately from the flight information 150.

The plan creation unit 104 includes at least an arrival place, a departure place, a cargo amount, and extreme information on the airplane.

Furthermore, in a case where there is a change in the flight information 150, the acquisition unit 102 acquires the flight information 150 after the change, and the plan creation unit 104 performs update processing of the charging plan. Various methods of detecting that a change has occurred in the flight information 150 are conceivable, and are exemplified below, but are not limited thereto.

(Example 1) Information indicating a change notification from a server (not illustrated) of an airline company and flight information 150 after the change are received.

(Example 2) In a case of receiving the flight delay information from the airline, the information processing device 100 displays a screen for receiving an input of a change on the display of the information processing device 100, and receives an input of a change content by an operation of the operator.

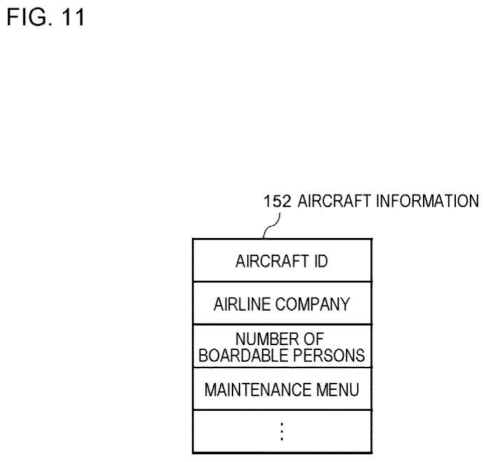

FIG. 11 is a diagram illustrating an example of a data structure of the aircraft information 152.

The aircraft information 152 is information indicating basic information on the aircraft. The aircraft information 152 can be acquired from a server (not illustrated) of each airline company and is stored in the storage device 120. The aircraft information 152 includes, for each aircraft, an aircraft ID, the number of persons who can board, and a maintenance menu.

In a case of creating the charging plan, the plan creation unit 104 may further use information related to the current remaining power amount of the electric vehicle 50. Therefore, the acquisition unit 102 acquires information regarding the current remaining power amount of the storage battery of the electric vehicle 50.

The information regarding the current remaining power amount of the storage battery of the electric vehicle 50 will be described in detail in an example embodiment to be described later.

### Operation Example

Hereinafter, an operation example of the information processing device 100 according to the example embodiment will be described.

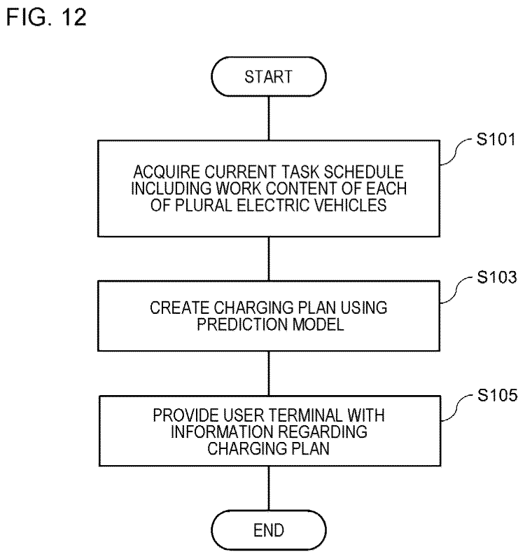

FIG. 12 is a flowchart illustrating an operation example of the information processing device 100 according to the example embodiment.

The acquisition unit 102 acquires the current task schedule including the work content of each of the plurality of electric vehicles 50 (step S101).

The plan creation unit 104 inputs the work content specified based on the task schedules of the plurality of electric vehicles 50 to the prediction model 122 associated with the vehicle type of each electric vehicle 50. Then, the plan creation unit 104 creates a charging plan of the plurality of electric vehicles 50 including the charging start timing for each electric vehicle 50 and the information regarding the power feeder 20 by using the output of the prediction model 122 (step S103). The provision unit 106 provides the user terminal 200 with information regarding the charging plan (step S105).

For example, the provision unit 106 causes the display of the user terminal 200 to display the notification screen 300 in FIG. 9 described above.

In addition, the acquisition unit 102 and the plan creation unit 104 repeatedly execute the processing (hereinafter, also referred to as update processing) in steps S101 and S103 described above. For example, by executing the update processing in real time every hour, the acquisition unit 102 and the plan creation unit 104 can update the charging plan associated with the change in real time, for example, in a case where the work content is changed (for example, a delay in the arrival-departure time of the flight or the like). Alternatively, the acquisition unit 102 and the plan creation unit 104 may execute the update processing every day before the start of work.

As described above, according to the present example embodiment, the information processing device 100 includes the acquisition unit 102, the plan creation unit 104, and the provision unit 106. The acquisition unit 102 acquires a current task schedule including the work content of each of the plurality of electric vehicles 50. The plan creation unit 104 inputs the work content specified based on the task schedules of the plurality of electric vehicles 50 to the prediction model 122 associated with the vehicle type of each electric vehicle 50. Then, the plan creation unit 104 creates a charging plan of the plurality of electric vehicles 50 including the charging start timing for each electric vehicle 50 and information regarding the power feeder 20 (for example, information indicating the location of the power feeder 20) by using the output of the prediction model 122. The provision unit 106 provides the user terminal 200 with information regarding the charging plan.

As described above, according to the present example embodiment, the charging plan can be created using the prediction model 122 machine-learned for the charging timing of a wide variety of electric vehicles 50 working at the airport, in consideration of the task schedule of each electric vehicle 50, and for each vehicle type of the electric vehicle 50. Therefore, according to the present example embodiment, it is possible to obtain a charging plan creating system, an information processing device, an information processing method, and a program that can perform appropriate determination in accordance with the current situation.

In addition, generally, work at an airport is performed by companies commissioned by each airline company. Therefore, it has been difficult to update the charging timing in consideration of work contents of a plurality of management companies, a sudden change in the arrival-departure time of the aircraft of each airline company, and results of the charging status of each electric vehicle.

According to the present example embodiment, it is possible to aggregate the work contents of a plurality of different management companies and update the charging timing in consideration of a sudden change in the arrival-departure time of the aircraft of each airline and the record of the charging status of each electric vehicle.

### SECOND EXAMPLE EMBODIMENT

### Functional Configuration Example

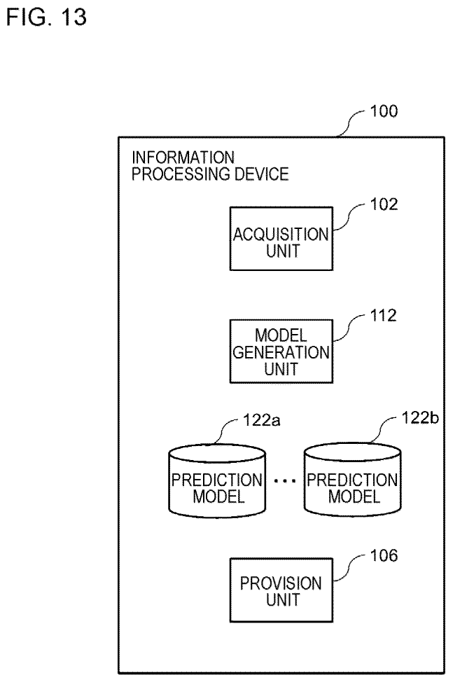

FIG. 13 is a functional block diagram illustrating a logical configuration example of an information processing device 100 according to an example embodiment. The present example embodiment is different from the above embodiment in that the present example embodiment has a configuration in which the prediction model 122 is machine-learned for each vehicle type. Although the plan creation unit 104 of the information processing device 100 of FIG. 1 or 6 is not illustrated in FIG. 13, the information processing device 100 of the present example embodiment can include the same configuration as the information processing device 100 of FIG. 1 or 6. In addition, the configuration of the present example embodiment may be combined with at least any one of the configurations of the other example embodiments as long as no contradiction occurs.

The information processing device 100 includes an acquisition unit 102, a model generation unit 112, and a provision unit 106. The acquisition unit 102 acquires past record data and the like as various types of information necessary for machine learning. The information for machine learning includes vehicle information 130 of the electric vehicle 50, vehicle battery information 132, and vehicle-specific charging history information 134.

The model generation unit 112 calculates a relational expression between the work content and the power consumption, and generates prediction models 122a, 122b, . . . of the power consumption for each vehicle type. The model generation unit 112 causes the prediction model 122 for each vehicle type to be learned using the past charging record of each electric vehicle 50, the past use record and business information on each power feeder 20, the flight schedule, the weather, and the like.

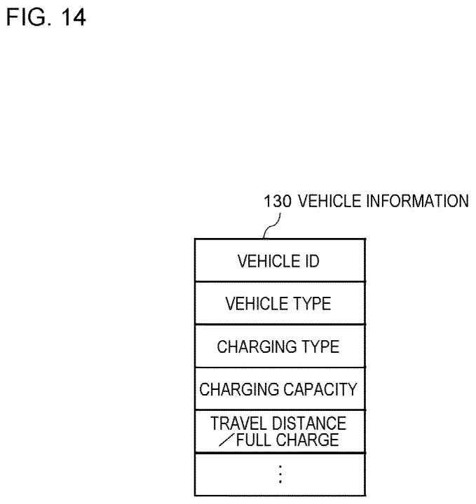

FIG. 14 is a diagram illustrating an example of a data structure of the vehicle information 130.

The vehicle information 130 includes basic information on the electric vehicle 50 for each electric vehicle 50. For example, the vehicle information 130 includes identification information that can identify the electric vehicle 50, information indicating a vehicle type of the electric vehicle 50, information indicating a charging type (information indicating normal charging support or rapid charging support) of a storage battery of the electric vehicle 50, a capacity of the storage battery of the electric vehicle 50, and a travel distance for full charge as information indicating a deterioration status of the storage battery of the electric vehicle 50. The travel distance for full charge of the electric vehicle 50 may be periodically calculated and updated using information (vehicle-specific charging history information 134 and vehicle battery information 132) indicating a charge record of a storage battery of the electric vehicle 50 to be described later.

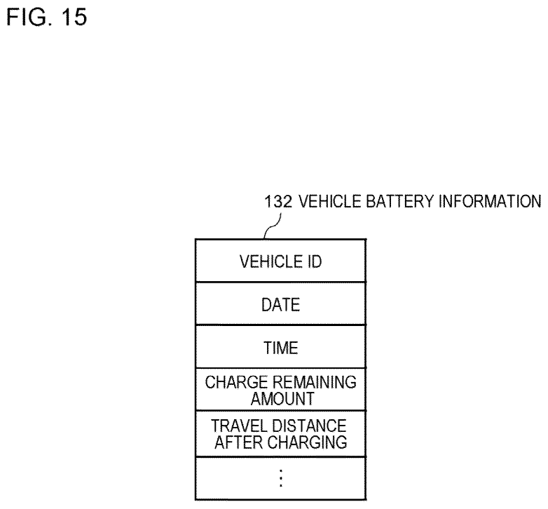

FIG. 15 is a diagram illustrating an example of a data structure of the vehicle battery information 132.

For each electric vehicle 50, the vehicle battery information 132 is stored in the storage device 120 by associating information indicating the remaining amount of the storage battery of the electric vehicle 50 collected periodically from the electric vehicle 50 with time information on the collection of the information. There are various methods of acquiring information indicating the remaining amount of the storage battery of the electric vehicle 50, and the method is not particularly limited.

(Example 1) The acquisition unit 102 may receive information indicating the remaining amount of the storage battery included in the computer 1000 that controls the electric vehicle 50 directly from the computer 1000 of the electric vehicle 50 using the wireless communication function.

(Example 2) The information indicating the remaining amount of the storage battery may be transmitted by the computer 1000 of the electric vehicle 50 to a server (not illustrated) that periodically manages the electric vehicle 50 using a wireless communication function. Then, the acquisition unit 102 may acquire information indicating the remaining amount of the storage battery of the electric vehicle 50 from the server.

(Example 3) A power feeder-specific power feeding history information 162 to be described later is received from a server (not illustrated) that manages information on the power feeder 20.

The information indicating the remaining capacity of the storage battery includes at least one of the remaining capacity (mAh) of the battery itself, information (%) indicating a ratio of the charge amount to the capacity of the storage battery, and information indicating a travel record (km/full charge) after full charge. The timing of information collection is not particularly limited, and may be in real time or at predetermined time intervals.

The vehicle battery information 132 of the example of FIG. 15 includes, for each electric vehicle 50, a vehicle ID, information indicating the date and time at which the information was acquired, the remaining amount (mAh) of the storage battery, and information indicating travel results (km/full charge) after full charge. The information indicating the date and time at which the information was acquired is not particularly limited, such as the time at which the information was received from the electric vehicle 50 or the time at which the information was stored in the storage device 120. Alternatively, in a case where the information indicating the remaining amount of the storage battery is accumulated in the memory of the electric vehicle 50 in time series and the time series information is acquired, the time information recorded in the time series information may be used.

The capacity of the storage battery that can be charged decreases due to aging deterioration. Therefore, the vehicle battery information 132 may further include information indicating the use start date and time of the battery. Then, based on the vehicle battery information 132, the model generation unit 112 may cause the prediction model 122 to learn using the information regarding the use period and the decrease in capacity of the storage battery of each electric vehicle 50.

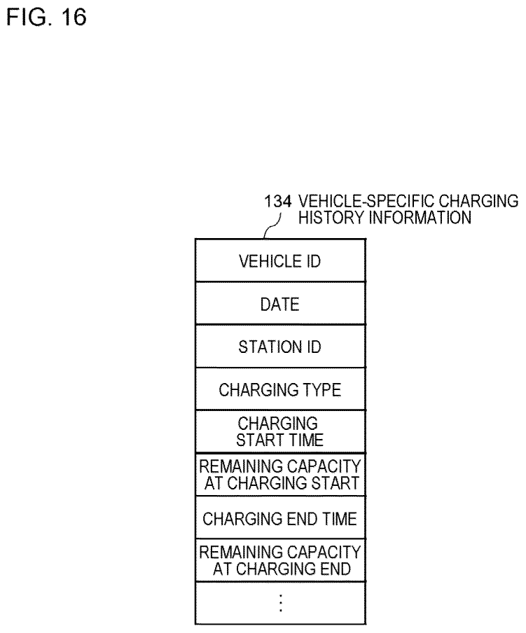

FIG. 16 is a diagram illustrating an example of a data structure of the vehicle-specific charging history information 134.

The vehicle-specific charging history information 134 indicates a history of a charging record for each electric vehicle 50. In the vehicle-specific charging history information 134, the power feeder-specific power feeding history information 162 acquired from each power feeder 20 is stored in the storage device 120 for each electric vehicle 50. The power feeder-specific power feeding history information 162 will be described later.

The vehicle-specific charging history information 134 includes, for each of the electric vehicles 50, a vehicle ID, information indicating a date on which the charging has been performed, identification information (hereinafter, referred to as a station ID) that can identify the power feeder 20 that has performed the charging, information indicating a charging type (normal charging or rapid charging), information indicating a time at which the charging has been started, information indicating a remaining capacity of a storage battery of the electric vehicle 50 at the start of the charging (before the start), information indicating a time at which the charging has ended, and information indicating a remaining capacity of a storage battery of the electric vehicle 50 at the end of the charging.

There are various conceivable methods for acquiring information on charging from the power feeder 20, and the method is not particularly limited.

(Example 1) The acquisition unit 102 may directly receive the power feeder-specific power feeding history information 162 included in the computer 1000 that controls the power feeder 20 from the computer 1000 of the power feeder 20 using the wireless communication function.

(Example 2) The power feeder-specific power feeding history information 162 may be transmitted by the computer 1000 of the electric vehicle 50 to a server (not illustrated) that periodically manages the power feeders 20 using a wireless communication function. Then, the acquisition unit 102 may acquire the power feeder-specific power feeding history information 162 from the server.

Furthermore, the machine learning information includes the flight information 150 and the aircraft information 152 described above, and weather information (not illustrated).

The information indicating the arrival-departure place of the aircraft can be used to learn a characteristic that the cargo amount per passenger increases or decreases depending on, for example, the area (country or the like) of the departure place or the arrival place.

Further, the machine learning information may include the power feeder information 160 and the power feeder-specific power feeding history information 162.

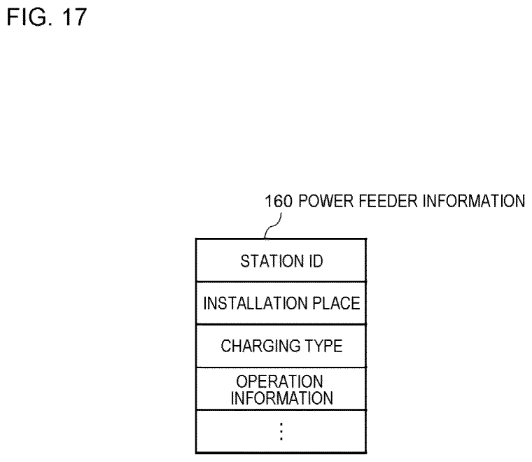

FIG. 17 is a diagram illustrating an example of a data structure of the power feeder information 160. The power feeder information 160 includes basic information on the power feeder 20 for each power feeder 20. For example, the power feeder information 160 includes, for each power feeder 20, a station ID, information indicating an installation place, information indicating a charging type, and information indicating an operation status. The information indicating the installation location can be indicated by latitude and longitude.

However, the information indicating the installation location may be machine-learned in association with map information in the airport. The map information in the airport includes information indicating the position of each facility in the airport. Each facility in the airport includes, for example, a dining room, a store, and a toilet for an employee used by a user of the electric vehicle 50, and an apron, a warehouse, and a place where maintenance is performed.

For example, since charging takes time, there are many users who take a break or take a meal until charging is completed. Therefore, the user tends to concentrate on the power feeder 20 which is close to a dining room, a store, and a toilet. As described above, the information indicating the installation location of the power feeder 20 enables machine learning of the relationship between the behavior of the user and the congestion of the power feeder 20.

In a case where the power feeders 20 are installed in a plurality of places, there is a power feeder 20 that is closed depending on a season (summer vacation, golden week, etc), a day of the week, or time. Therefore, the information indicating the operation status includes an operation schedule for each power feeder 20.

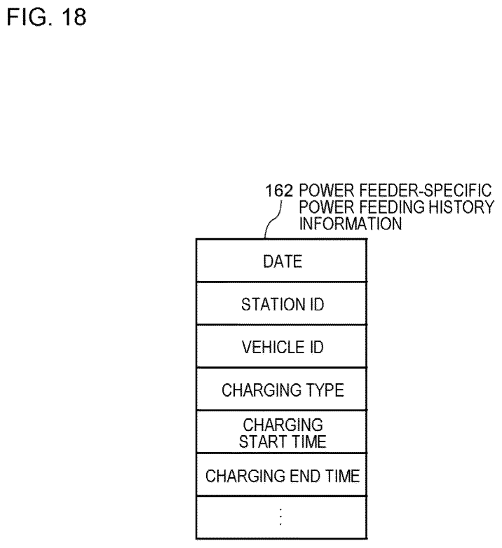

FIG. 18 is a diagram illustrating an example of a data structure of the power feeder-specific power feeding history information 162. The power feeder-specific power feeding history information 162 accumulates information on power feeding for each power feeder 20 and stores the information in the storage device 120. The above-described vehicle-specific charging history information 134 is obtained by acquiring information on the power feeder-specific power feeding history information 162 and storing the information in the storage device 120 for each electric vehicle 50.

The power feeder-specific power feeding history information 162 includes, for each power feeder 20 on a daily basis, as information for each power feeding, the vehicle ID of the electric vehicle 50 that has fed power, information indicating the charging type of the power feeding, information indicating the start time of the power feeding, and information indicating the end time of the power feeding. There are various methods for acquiring the vehicle ID of the electric vehicle 50. For example, the vehicle ID or the user ID can be acquired from a recording medium presented by the user at the time of power feeding using a reading device (not illustrated) that reads the recording medium (for example, an IC card, a two-dimensional code displayed on the user terminal 200, or the like) in which the vehicle ID or the user ID is recorded. Alternatively, the vehicle ID may be specified and acquired by analyzing an image of a license plate of the electric vehicle 50 generated by a camera installed in the power feeder 20.

The plan creation unit 104 inputs the work content of the day of each electric vehicle 50 to the prediction model 122, and outputs a predicted value of the power consumption amount based on the work content of the day of each electric vehicle 50. For example, the plan creation unit 104 calculates the remaining battery level predicted for each time from the predicted power consumption amount associated with the daily work content. Further, the plan creation unit 104 specifies the recommended charging start time as the scheduled charging time by using at least the time at which the calculated remaining battery level falls below the threshold and the start time and end time of the work included in the work content. However, as described above, other information can also be used to specify the charging start time. The plan creation unit 104 stores these pieces of information in the storage device 120 as the power consumption prediction information 144 for each electric vehicle 50.

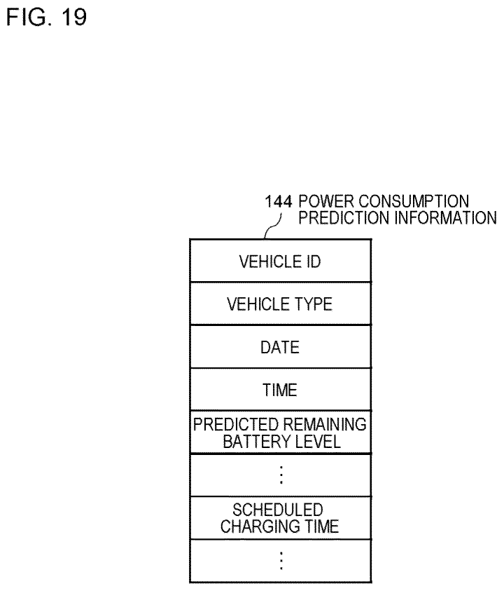

FIG. 19 is a diagram illustrating a data structure example of the power consumption prediction information 144.

The power consumption prediction information 144 includes, for each electric vehicle 50, a vehicle ID, information indicating a vehicle type, information indicating a date, information indicating a predicted remaining battery level for each time, and information indicating a scheduled charging time.

In addition, the plan creation unit 104 generates the usage prediction information on each power feeder 20 according to the charging plan of each electric vehicle 50 generated using the prediction model 122, and stores the usage prediction information in the storage device 120 as the power feeder usage prediction information 164.

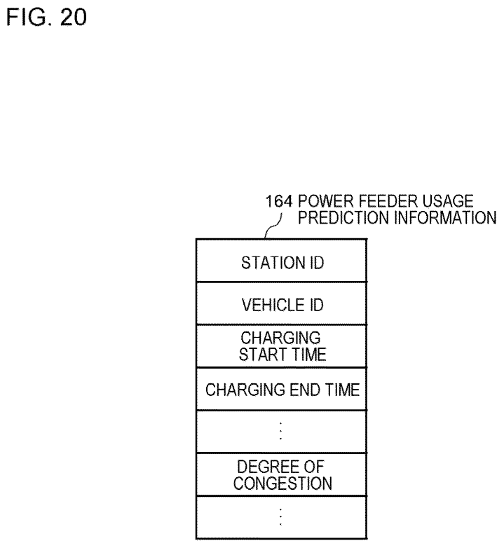

FIG. 20 is a diagram illustrating an example of a data structure of the power feeder usage prediction information 164 on the power feeder 20 on that day.

The power feeder usage prediction information 164 includes the station ID for each power feeder 20, the vehicle ID of the charged electric vehicle 50 for each predicted charging schedule, the scheduled start time of the charging, and the scheduled end time of the charging, and may further include information indicating the degree of congestion. However, since the power feeder usage prediction information 164 indicates the predicted usage status on that day based on the past record information, the electric vehicle 50 may not be specified. That is, the power feeder usage prediction information 164 may not include the vehicle ID. Furthermore, the information indicating the degree of congestion may be the degree of congestion for each time slot or the degree of congestion in one day.

The provision unit 106 uses the power consumption prediction information 144 or the power feeder usage prediction information 164 to generate a screen indicating various types of information to be described later, and causes the user terminal 200 to display the screen.

### Operation Example

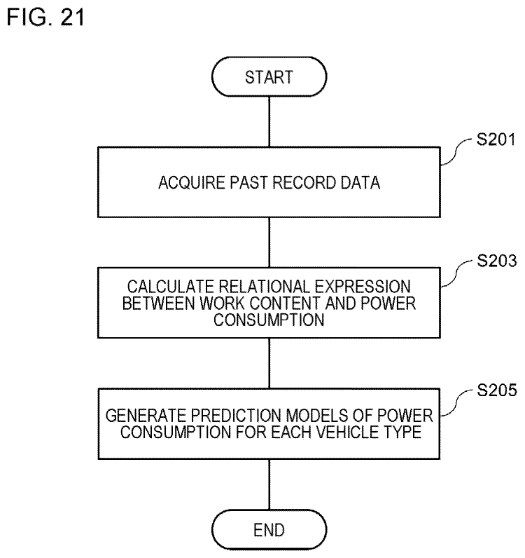

Hereinafter, the operation of the information processing device 100 will be described with reference to FIGS. 21 and 12.

FIG. 21 is a flowchart illustrating an operation example of the information processing device 100 according to the example embodiment.

First, generation of the prediction model 122 will be described with reference to FIG. 21.

The acquisition unit 102 acquires past record data as various types of information necessary for machine learning (step S201). The model generation unit 112 calculates a relational expression between the work content and the power consumption (step S203). The model generation unit 112 generates the prediction models 122a, 122b, . . . of power consumption for each vehicle type (step S205). The generated prediction models 122a, 122b, . . . are stored in the storage device 120.

Next, generation of a charging plan using the created prediction model 122 will be described according to the flow illustrated in FIG. 12.

The acquisition unit 102 acquires the current task schedule including the work content of each of the plurality of electric vehicles 50 (step S101).

The plan creation unit 104 inputs the specified work content of the day to the prediction model 122 associated with the vehicle type of each electric vehicle 50 based on the task schedules of the plurality of electric vehicles 50. Then, the plan creation unit 104 creates a charging plan of the plurality of electric vehicles 50 including the charging start timing for each electric vehicle 50 and the information regarding the power feeder 20 by using the output of the prediction model 122 (step S103).

The provision unit 106 generates various screens by using the output of the prediction model 122 and causes the user terminal 200 to display the screens (step S105).

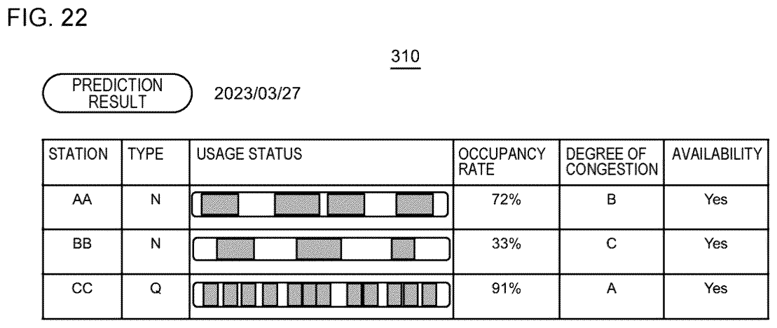

FIG. 22 is a diagram illustrating an example of a predicted usage status screen 310 illustrating a predicted usage status of each power feeder 20 on the day. The provision unit 106 generates the predicted usage status screen 310 using the power feeder usage prediction information 164 and displays the screen on the display of the user terminal 200.

The predicted usage status screen 310 includes information indicating a station name, a charging type, a usage status, an occupancy rate, the degree of congestion, and availability for each power feeder 20.

The charging type indicates normal charge (N) or rapid charge (Q). The usage status indicates, for example, the time during which the power feeder 20 is used within the business hours (for example, from 0:00 to 24:00) using a band graph. The occupancy rate indicates a ratio of the time during which the power feeder 20 is used to the business hours. The degree of congestion is information indicating a congestion state of the power feeder 20. In this example, the degree of congestion is indicated by ranks A to C according to the waiting time. In this example, the waiting time of the rank A is equal to or more than 60 minutes, the waiting time of the rank B is equal to or more than 10 minutes and less than 60 minutes, and the waiting time of the rank C is less than 10 minutes, but the ranking is an example and is not limited thereto.

The availability is, for example, information indicating whether the power feeder 20 can be used on the day. Since the day on which the power feeder 20 conducts business may be limited, information indicating availability on the day is useful. However, the information indicating availability is not necessarily required, and for example, the predicted usage status screen 310 may include only the power feeder 20 that can be used on the day. Furthermore, in an example embodiment to be described later, the information indicating availability is further information indicating whether it is available for each electric vehicle 50 according to the charging plan. That is, not only the presence or absence of the operation of the power feeder 20 itself but also a result of determining whether the power feeder can be used according to the task schedule of the electric vehicle 50 is shown. Details will be described later.

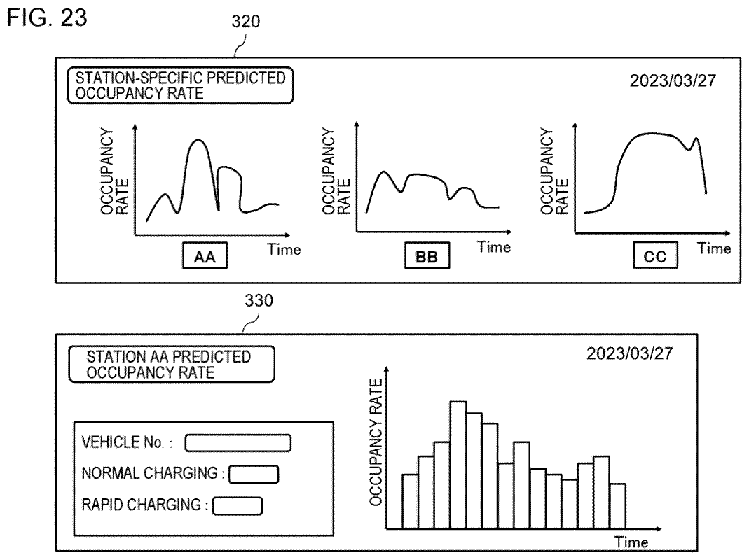

FIG. 23 is a diagram illustrating an example of a detail screen in which a predicted usage status of each power feeder 20 is graphed.

The predicted usage status screen 320 for each power feeder 20 includes a graph showing a time-series change in the occupancy rate predicted for each power feeder 20 on that day. Further, the predicted usage status detail screen 330 includes a graph showing a detailed usage status of the power feeder 20 recommended for charging for a specific electric vehicle 50.

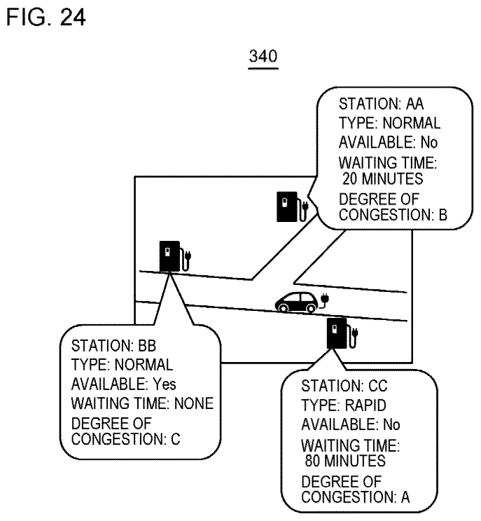

FIG. 24 is a diagram illustrating an example of the predicted usage status screen 340 in the map format. The predicted usage status screen 340 includes information indicating the position of the power feeder 20 in the map format of the predicted usage status screen 320 for each power feeder in FIG. 22 described above.

On the predicted usage status screen 340, for example, information indicating the position of the power feeder 20 (image element such as an icon) and information indicating the current position of the electric vehicle 50 (image element such as an icon) are displayed in a superimposed manner on a map. Further, the predicted usage status screen 340 includes the same information indicating the current status of each power feeder 20 as the predicted usage status screen 310. The information on the power feeder 20 includes information indicating the name of the power feeder 20, information indicating a charging type, information indicating availability, information indicating a current waiting time, and information indicating the current degree of congestion in association with the position of the power feeder 20. In this example, the associated information is included in the balloon image indicating the position of each power feeder 20, but the method of associating the power feeder 20 with the information is not limited thereto. For example, in a case of receiving an operation such as a touch, a long press, a click, or a mouseover on an icon representing each of the power feeders 20, the provision unit 106 may display a window that displays information regarding the power feeders 20.

As described above, the information processing device 100 according to the present example embodiment includes the acquisition unit 102, the model generation unit 112, and the provision unit 106. The acquisition unit 102 acquires past record data and the like as various types of information necessary for machine learning. The model generation unit 112 calculates a relational expression between the work content and the power consumption, and generates prediction models 122a, 122b, . . . of the power consumption for each vehicle type. The model generation unit 112 causes the prediction model 122 for each vehicle type to be learned using the past charging record of each electric vehicle 50, the past use record and business information on each power feeder 20, the flight schedule, the weather, and the like.

As described above, according to the present example embodiment, the same effects as those of the above example embodiment are obtained, and the prediction model 122 for each vehicle type is learned using the past charging record of each electric vehicle 50, the past usage record and sales information on each power feeder 20, the flight schedule, the information regarding the weather, and the like, in such a way that it is possible to generate a more accurate charging plan in accordance with the actual situation. By efficiently performing charging according to the charging plan, congestion of the power feeder 20 can be alleviated, and efficiency (operation rate) of each operation of the electric vehicle 50 can also be improved.

### Third Example Embodiment

The present example embodiment is similar to the above example embodiment except that the present example embodiment has a configuration of generating a charging plan using the optimization model 124 that outputs the charging plan using the output of the prediction model 122 as an input. The charging plan creating system 1 of the present example embodiment further includes an optimization model 124 in addition to the configuration of the charging plan creating system 1 of the above-described example embodiment in FIG. 3. The configuration of the present example embodiment may be combined with at least any one of the configurations of other example embodiments as long as no contradiction occurs.

### System Overview

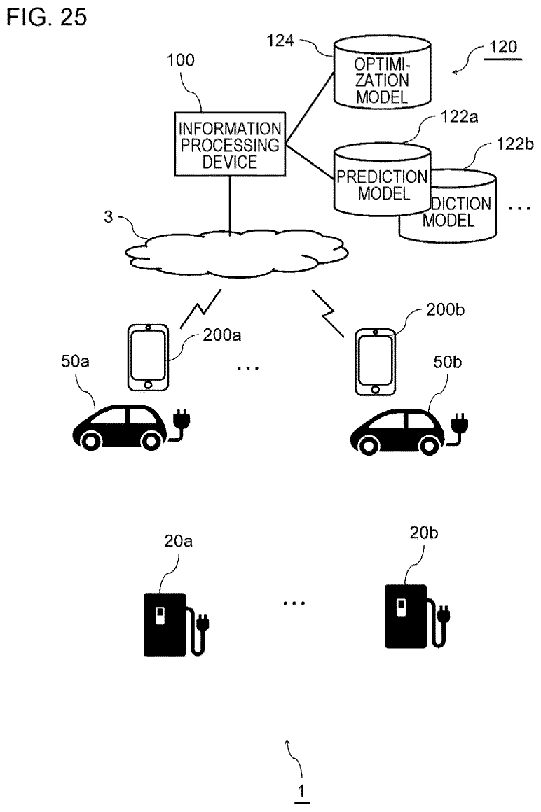

FIG. 25 is a diagram conceptually illustrating a system configuration of the charging plan creating system 1 according to the example embodiment. The charging plan creating system 1 has a configuration similar to that of the charging plan creating system 1 of FIG. 3, and further includes an optimization model 124.

### Functional Configuration Example

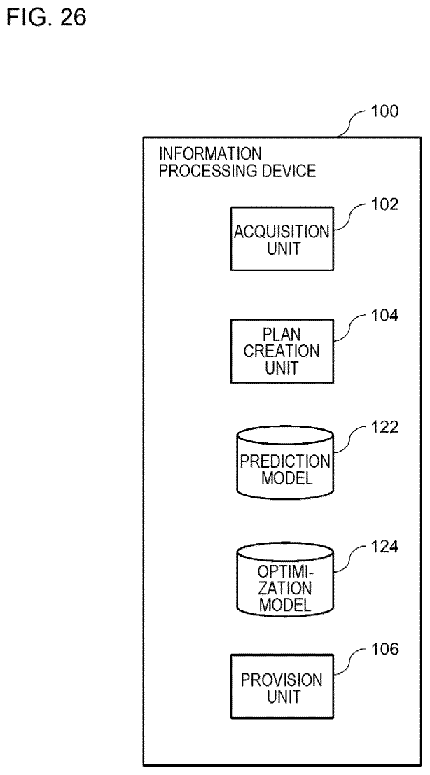

FIG. 26 is a functional block diagram illustrating a logical configuration example of the information processing device 100 according to the example embodiment. The information processing device 100 has the same configuration as the information processing device 100 in FIG. 6 and further includes an optimization model 124.

The plan creation unit 104 creates a charging plan using the optimization model 124 (second model) that receives, as an input, the output of the prediction model 122 (first model) and outputs the charging plan.

Specifically, the plan creation unit 104 inputs information including the work content of the electric vehicle 50 to the associated model-by-model prediction model 122 for each vehicle type of the plurality of electric vehicles 50, and outputs the predicted power consumption of the electric vehicle 50. Then, the plan creation unit 104 inputs the predicted power consumption amount of each electric vehicle 50 output from the prediction model 122 for each vehicle type of the electric vehicle 50 to the optimization model 124, and outputs the charging plan of each electric vehicle 50.

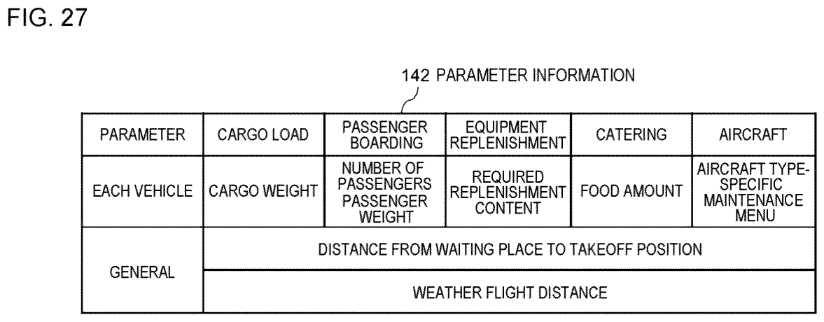

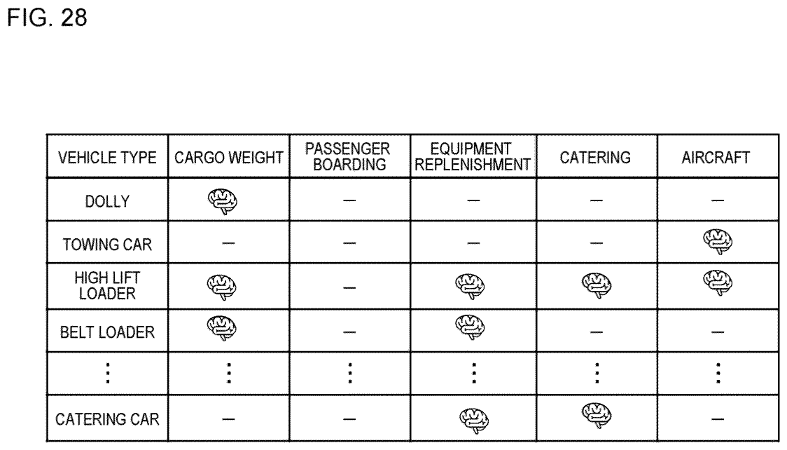

Parameters required for optimization using the optimization model 124 are different for each vehicle type. FIGS. 27 and 28 are diagrams illustrating the parameter information 142 used for optimization and the optimization model 124.

The parameter information 142 includes, for example, a parameter related to a cargo load, a parameter related to passenger boarding, a parameter related to equipment replenishment, a parameter related to catering, and a parameter related to an aircraft. The parameter related to the cargo load includes the weight of the cargo for each vehicle. Parameters related to passenger boarding include the number of passengers and the total weight of passengers for each vehicle. The parameter related to equipment replenishment includes information indicating the content of equipment that needs to be replenished for each vehicle. Parameters related to catering include the type and quantity or weight of food and beverages loaded on a vehicle-by-vehicle basis. The parameter related to the aircraft includes information indicating the type of aircraft to be worked on for each vehicle and the maintenance menu item.

The optimization model 124 extracts the parameters shown in the correspondence table of FIG. 28 from each piece of information for each vehicle type, analyzes the extracted parameters, optimizes the charging plan, and outputs the optimized charging plan. For example, since a dolly tractor is the electric vehicle 50 that carries the container, a parameter related to the cargo load of the container is used for analysis. Since a towing tractor (in the figure, indicated as “towing car”) is the electric vehicle 50 that tows the aircraft, parameters related to the aircraft are used for analysis. Since a high lift loader is the electric vehicle 50 that loads the cargo container into the cargo compartment, it includes parameters related to the cargo load, parameters related to equipment replenishment, parameters related to catering, and parameters related to the aircraft. However, these are merely examples, and the present invention is not limited thereto.

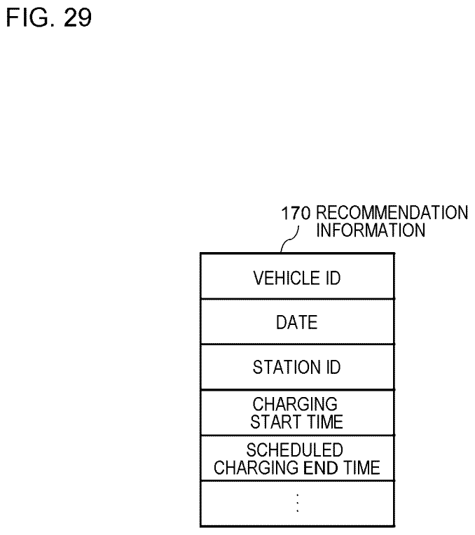

The charging plan for each electric vehicle 50 output from the plan creation unit 104 is stored in the storage device 120 as the recommendation information 170. FIG. 29 is a diagram illustrating an example of a data structure of the recommendation information 170. The recommendation information 170 includes a daily charging plan for each electric vehicle 50. Specifically, the recommendation information 170 includes the vehicle ID of the electric vehicle 50 as a target of the charging plan, information indicating the date of the charging plan, the station ID of the power feeder 20 as a recommended charging place, information indicating the charging start time of the charging plan, and information indicating the scheduled charging end time.

The provision unit 106 may notify the user terminal 200 of a recommended charging plan in accordance with the charging plan created by the plan creation unit 104. For example, the provision unit 106 notifies the user terminal 200 of the recommended charging schedule before the start of work or a predetermined time (for example, 30 minutes before, or the like, or user setting may be received) before the recommended charging start time. Although various notification contents are conceivable, for example, a notification indicating that the charging plan has been created may be output to the user terminal 200. The notification may be performed by a presentation method according to the setting of the user, and is exemplified below, but is not limited thereto.

(Example 1) A badge indicating that there is a new notification is displayed on the icon of the application of the user terminal 200.

(Example 2) A notification indicating that the charging plan has been created is displayed on the lock screen or the home screen of the user terminal 200.

(Example 3) A sound or a voice indicating that there is a notification from a speaker (not illustrated) of the user terminal 200 is output.

(Example 4) A vibration unit (not illustrated) of the user terminal 200 is vibrated in accordance with the notification.

The provision unit 106 causes the display of the user terminal 200 to display a charging plan screen 350 (alternatively, the notification screen 300 in FIG. 9) including information indicating the recommended charging place in the charging plan, the charging start time, and the scheduled end time of the charging.

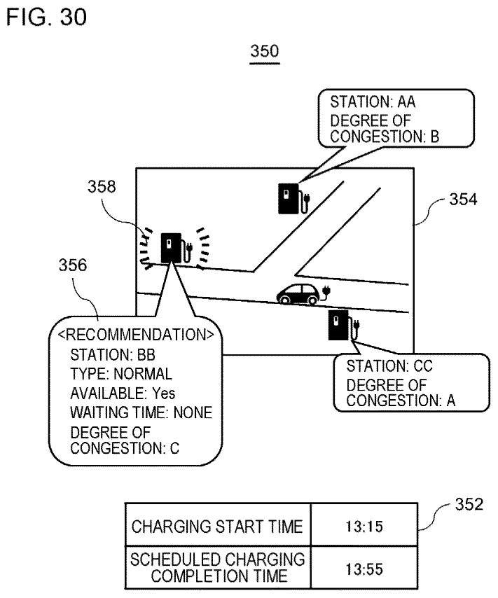

FIG. 30 is a diagram illustrating an example of the charging plan screen 350. The charging plan screen 350 includes a charging plan display field 352 that displays a charging start time recommended in the charging plan and a scheduled end time of the charging, and a map display field 354 that indicates a charging place recommended in the charging plan. The map displayed in the map display field 354 includes an icon indicating the position of the power feeder 20 and an icon indicating the position of the electric vehicle 50. Further, the map displayed in the map display field 354 includes a display field 356 for displaying information on each power feeder 20. In this example, the associated information is included in the balloon image indicating the position of each power feeder 20, but the method of association is not limited thereto. For example, in a case of receiving an operation such as a touch, a long press, a click, or a mouseover on an icon representing each of the power feeders 20, the provision unit 106 may display a window that displays information regarding the power feeders 20.

The display field 356 includes, for example, information indicating that charging in the power feeder 20 is recommended, a name of the power feeder 20, a charging type, information indicating availability, a waiting time, and the degree of congestion. On the other hand, in the case of the power feeder 20 that is not recommended, the display field 356 includes the name of the power feeder 20 and the degree of congestion. That is, for the power feeder 20 that is not recommended, only the minimum necessary information is displayed in the display field 356. However, for the power feeder 20 that is not recommended, the display field 356 may not be displayed on the charging plan screen 350. In addition, whether to perform these displays or display items may be set by a user operation in a setting menu or the like of the charging plan creating system 1. The provision unit 106 creates the charging plan screen 350 based on the set contents.

Furthermore, on the charging plan screen 350, the provision unit 106 may perform highlight 358 on the position on the map of the power feeder 20 recommended as the charging place. The highlight 358 may be emphasized in such a way that the user can immediately grasp the recommended position of the power feeder 20. The highlighting method is not particularly limited, and the icon of the power feeder 20 may be displayed in a blinking manner, in a 3D manner, in an animation manner, or in the vicinity of the icon, a mark or a character for calling attention to the user may be displayed.

### Operation Example

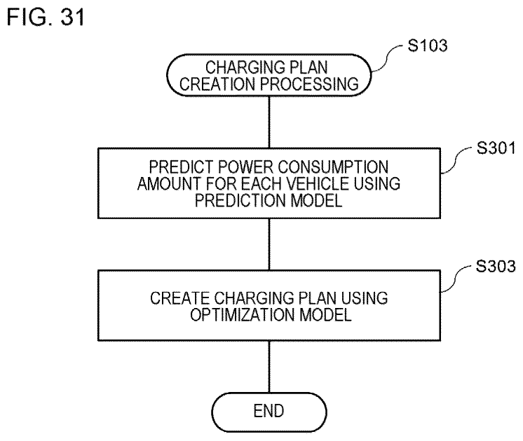

FIG. 31 is a flowchart illustrating a detailed procedure of the charging plan creation processing in step S103 of the flowchart of FIG. 2 or 12. Hereinafter, an operation example of the information processing device 100 will be described with reference to FIGS. 12 and 31.

First, the acquisition unit 102 acquires the current task schedule including the work content of each of the plurality of electric vehicles 50 (step S101 in FIG. 12).

Then, the plan creation unit 104 predicts the power consumption amount for each electric vehicle 50 using the prediction model 122 for each vehicle type (step S301 in FIG. 31). Specifically, the plan creation unit 104 inputs, for example, information including the work content of the electric vehicle 50 of the day to the associated model-by-model prediction model 122 for each vehicle type of the plurality of electric vehicles 50, and outputs the predicted power consumption of the electric vehicle 50.

Then, the plan creation unit 104 creates a charging plan using the optimization model 124 (step S303 in FIG. 31). Specifically, the plan creation unit 104 inputs the predicted power consumption amount of each electric vehicle 50 output from the prediction model 122 for each vehicle type of the electric vehicle 50 to the optimization model 124, and outputs the charging plan of each electric vehicle 50. At this time, the optimization model 124 extracts parameters for each vehicle type from each piece of information and performs optimization processing.

Then, the provision unit 106 generates the charging plan screen 350 of FIG. 30 and displays the charging plan screen on the display of the user terminal 200. Specifically, the provision unit 106 first acquires the associated user ID with reference to the user information 180 based on the generated vehicle ID of the charging plan of the electric vehicle 50. Then, the charging plan screen 350 is uploaded to a web page browsable by the user with the user ID, and a notification indicating that the charging plan has been created is output. The notification output method is as described above. For example, in a case of using the application, the provision unit 106 displays a notification screen on a home screen or the like of the user terminal 200. In a case of using the web site, the provision unit 106 displays a notification screen on the front page dedicated to the user.

Furthermore, the provision unit 106 may acquire a terminal ID associated with the vehicle ID and transmit the notification information to a telephone number or a mail address of the user terminal 200. In a case of the telephone number, the provision unit 106 transmits the notification information by short message service (SMS).

As described above, the information processing device 100 according to the present example embodiment further includes the optimization model 124. The plan creation unit 104 uses the output of the prediction model 122 as an input and the optimization model 124 having the charging plan as an output to create the charging plan. The optimization model 124 is associated with parameters necessary for optimization for each vehicle type. The optimization model 124 extracts parameters for each vehicle type from each piece of information and performs optimization processing.

As described above, according to the present example embodiment, the same effects as those of the above example embodiment are obtained, and further, optimization is performed according to the characteristics for each vehicle type, in such a way that a more accurate charging plan can be created. In addition, since the information on the parameter necessary for each vehicle type is extracted and analyzed, the optimization processing can be efficiently performed.

### FOURTH EXAMPLE EMBODIMENT

### System Overview

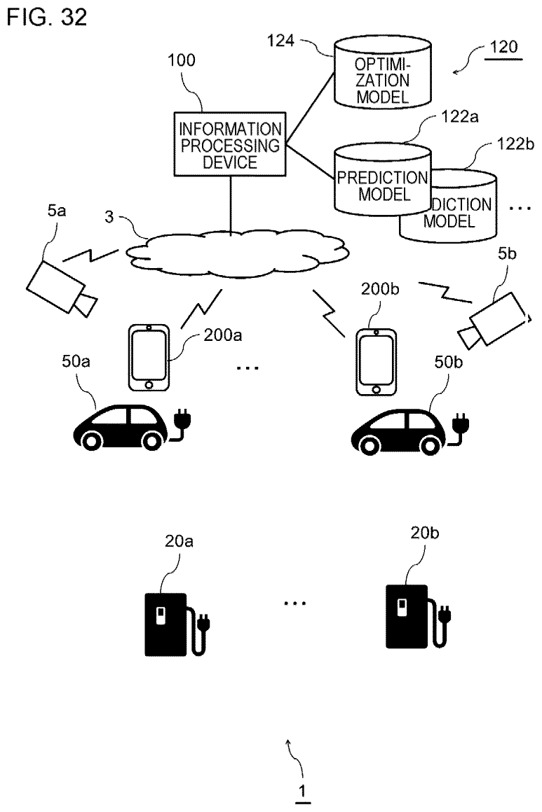

FIG. 32 is a diagram conceptually illustrating a system configuration of the charging plan creating system 1 according to the example embodiment. The present example embodiment is different from the above-described embodiment in that the present example embodiment has a configuration for specifying a work situation of the electric vehicle 50 by processing a captured image. The charging plan creating system 1 of FIG. 32 further includes a plurality of camera 5a, camera 5b, . . . (hereinafter, in a case where it is not particularly necessary to distinguish, referred to as the camera 5) in addition to the charging plan creating system 1 of FIG. 25. However, the present example embodiment may be combined with the charging plan creating system 1 of FIG. 3.

The camera 5 includes a lens and an imaging element such as a charge coupled device (CCD) image sensor and is, for example, a network camera such as an Internet protocol (IP) camera. The network camera has, for example, a wireless local area network (LAN) communication function, and is connected to the information processing device 100 via the communication network 3, that is, a relay device (not illustrated) such as a router. Then, the camera 5 may include a mechanism that performs control of the orientation of the camera body and the lens, zoom control, focusing, and the like by following the movement of the electric vehicle 50 and the person.

The image generated by the camera 5 may be captured in real time and transmitted to the information processing device 100. However, the image transmitted to the information processing device 100 may not be directly transmitted from the camera 5, and may be an image delayed by a predetermined time. The image captured by the camera 5 may be temporarily stored in another storage device 120, and the information processing device 100 may read the image sequentially or at predetermined intervals from the storage device 120. Furthermore, the image transmitted to the information processing device 100 may be a moving image, but may be a frame image at predetermined intervals or a still image.

The camera 5 is installed for each of a plurality of areas in order to generate an image obtained by imaging the electric vehicle 50 performing work in the apron of the airport. The image generated by each camera 5 is stored in the storage device 120 in association with identification information that can identify the camera 5. Further, as the information on each camera 5, identification information (hereinafter, referred to as a camera ID) of the camera 5 and information (for example, information capable of specifying a region of an imaging target) indicating an installation position of the camera 5 are stored in association with each other.

The image generated by the camera 5 is transmitted to the information processing device 100 and subjected to image processing. The image processing is performed by an image processing apparatus that is not recommended. First, the image processing apparatus specifies the electric vehicle 50 in the image. Then, the image processing apparatus specifies the vehicle ID of the electric vehicle 50 from the area of the number plate of the electric vehicle 50. Then, the image processing apparatus specifies the work situation for each electric vehicle 50 by image analysis. The work situation includes, for example, “approaching before the start of work”, “start of work”, “in progress of work”, “end of work”, and “during separation after completion of work”. The information processing device 100 stores the time at which each work situation of the electric vehicle 50 is changed, which is specified by the image processing apparatus, in the storage device 120 as the vehicle-specific work situation information 146.

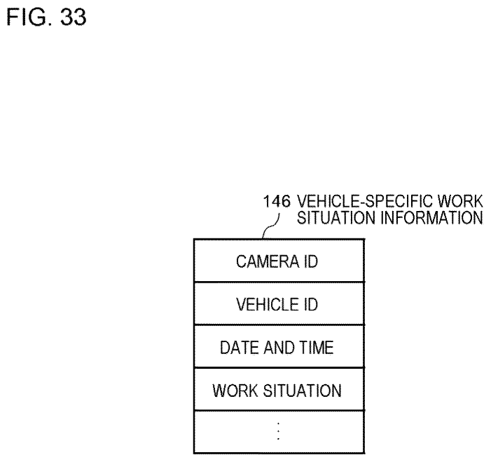

FIG. 33 is a diagram illustrating a data structure example of the vehicle-specific work situation information 146.

The vehicle-specific work situation information 146 includes, for each camera 5, information indicating the date and time each time the work situation is specified and information indicating the specified work situation for each specified vehicle ID in association with the camera ID. As described above, since the information indicating the imaging area is associated with the camera ID, the information processing device 100 can specify the place where the electric vehicle 50 is working from the camera ID.

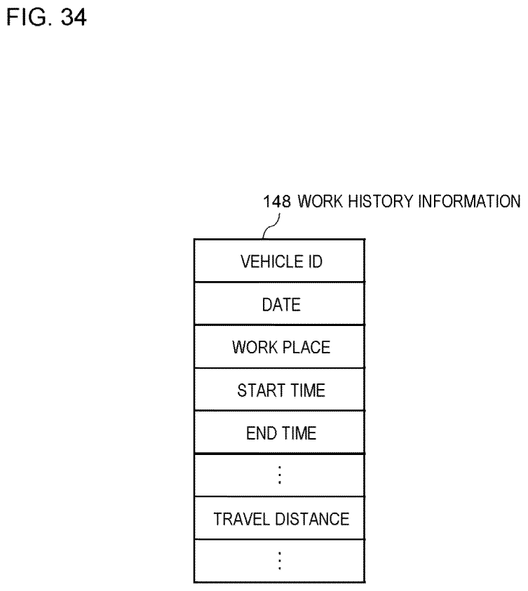

FIG. 34 is a diagram illustrating a data structure example of the work history information 148.

The work history information 148 is stored in the storage device 120 as history information for each work for each electric vehicle 50, the vehicle-specific work situation information 146 obtained by analyzing the captured image of the camera 5. For example, the work history information 148 includes, for each electric vehicle 50, for each date and for each work, information indicating an imaging area and information indicating a work place specified from an image analysis result in the camera ID, a work start time, and a work end time. Furthermore, the work history information 148 may include information indicating a travel distance for each date for each electric vehicle 50. The travel distance may be recorded for each work. For the travel distance, information indicating the travel distance included in the computer 1000 of the electric vehicle 50 may be received using a wireless communication function. The work history information 148 can also be used for learning of at least one of the prediction model 122 and the optimization model 124 by the model generation unit 112.

### Functional Configuration Example

The information processing device 100 according to the example embodiment has the same configuration as the information processing device 100 according to any one of the above example embodiments. Here, it is assumed that the configuration is the same as that of the information processing device 100 in FIG. 26, and the description will be given with reference to FIG. 26. However, the configuration of the present example embodiment may be combined with at least one of the configurations of other example embodiments as long as no contradiction occurs.

The acquisition unit 102 further acquires the vehicle-specific work situation information 146 described above. The vehicle-specific work situation information 146 is further used while the plan creation unit 104 creates a charging plan. For example, in a case where it is detected that there is a difference between the task schedule and the progress status of the actual work, the plan creation unit 104 updates the charging plan to match the current status. Specifically, information (vehicle-specific work situation information 146) indicating an actual work status in which a difference occurs from the task schedule is input to the prediction model 122 associated with the vehicle type of the electric vehicle 50, and the predicted power consumption of the electric vehicle 50 is acquired as an output. Then, the plan creation unit 104 inputs the output of the prediction model 122 to the optimization model 124, and acquires a new charging plan as an output.

However, in a case where it is assumed that the plurality of electric vehicles 50 involved in the work at the airport is affected by a flight delay or the like, the charging plan may be sequentially updated by periodically repeating the processing of the acquisition unit 102 and the plan creation unit 104. However, in a case where a situation in which the charging schedule of the electric vehicle 50 needs to be updated occurs due to a delay in work of only the specific electric vehicle 50 or the like, the charging plan may be updated in such a way as to minimize the influence on the other electric vehicles 50.

Therefore, the plan creation unit 104 may perform the following processing before the processing of updating the entire charging plan.

For example, the plan creation unit 104 determines whether the difference from the task schedule affects the original charging schedule. Then, the plan creation unit 104 further determines whether the charging schedule of another electric vehicle 50 is affected in a case where the start time of the charging schedule is delayed.

For example, in a case where there is no influence on the original schedule and in a case where there is no influence on the charging schedule of the other electric vehicle 50, the processing of updating the charging plan is not performed. Furthermore, in a case where there is an influence on the charging schedule of the other electric vehicle 50, the plan creation unit 104 first selects the power feeder 20 that does not include the charging schedule of the other electric vehicle 50, and updates the charging plan of the electric vehicle 50. In a case where there is no power feeder 20 that does not include a charging schedule of another electric vehicle 50, the entire charging plan including the plurality of electric vehicles 50 is updated.

Furthermore, the work situation of each electric vehicle 50 can be used for machine learning of the optimization model 124. The model generation unit 112 causes the optimization model 124 to learn using the vehicle-specific work situation information 146 that is a result of the work situation of each electric vehicle 50. For example, the charging time of each electric vehicle 50 may be as short as possible and the number of times of charging is small. In other words, the influence on the operation due to the long charging time may be minimized in such a way that the operation is not delayed. The model generation unit 112 causes the optimization model 124 to learn the vehicle-specific work situation information 146 that is the actual work situation, thereby generating the optimization model 124 that can be optimized to improve the work efficiency of the electric vehicle 50.

As described above, the charging plan creating system 1 of the present example embodiment includes the plurality of cameras 5. The information processing device 100 processes the image generated by the camera 5 and specifies the work situation of each electric vehicle 50. Further, the acquisition unit 102 acquires the specified work situation. The plan creation unit 104 updates the charging plan using the work situation.

As described above, according to the present example embodiment, the same effects as those of the above example embodiment can be obtained, and further, the charging plan can be updated according to the actual work situation. Therefore, not only the case where the work content of the electric vehicle 50 is changed due to the change of the flight (for example, the arrival-departure delay), but also the work delay or the work acceleration of the specific electric vehicle 50 can be dealt with in real time.

Although the example embodiments of the present invention have been described above with reference to the drawings, these are examples of the present invention, and various configurations other than the above can be used.

### OTHER EXAMPLE EMBODIMENTS

### Provision of Reservation Status Information

For example, the provision unit 106 may cause each user terminal 200 to display a reservation screen 400 indicating a reservation status of each power feeder 20. For example, in a case where the press of the reservation button 308 on the notification screen 300 in FIG. 9 is received, the reservation screen 400 is displayed on the display of the user terminal 200.

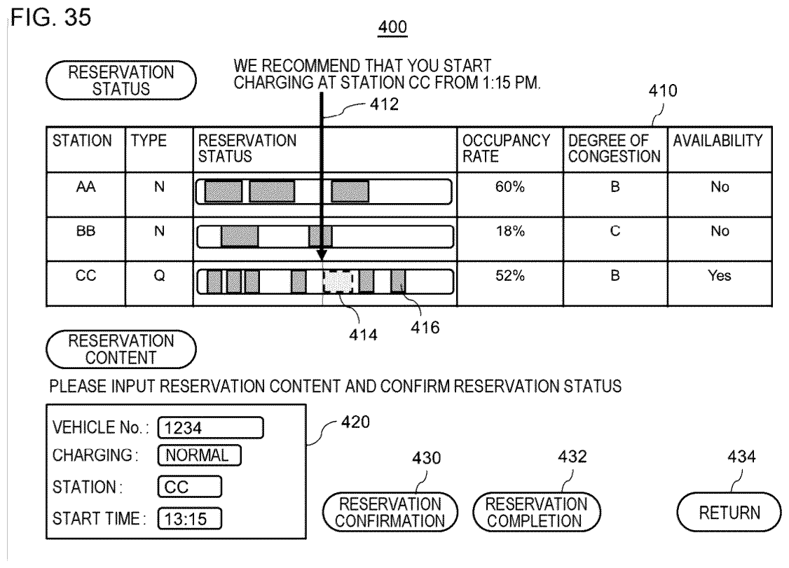

FIG. 35 is a diagram illustrating an example of the reservation screen 400.

The reservation screen 400 includes a reservation status display field 410, a reservation information display field 420, a reservation confirmation button 430, a reservation completion button 432, and a return button 434.

In the reservation status display field 410, a list similar to the predicted usage status screen 310 in FIG. 22 is displayed. Specifically, the reservation status display field 410 includes information indicating a station name, a charging type, a reservation status, an occupancy rate, the degree of congestion, and availability for each power feeder 20.

The charging type indicates normal charge (N) or rapid charge (Q). The reservation status indicates, for example, the time during which the power feeder 20 is reserved for use within the business hours (for example, from 0:00 to 24:00) using a band graph. The occupancy rate indicates a ratio of the time during which the power feeder 20 is reserved to the business hours. The degree of congestion is information indicating a congestion state of the power feeder 20. In this example, the degree of congestion is indicated by ranks A to C according to the waiting time. In this example, the waiting time of the rank A is equal to or more than 60 minutes, the waiting time of the rank B is equal to or more than 10 minutes and less than 60 minutes, and the waiting time of the rank C is less than 10 minutes, but the ranking is an example and is not limited thereto.

The availability is, for example, information indicating whether the power feeder 20 can be used on the day. Furthermore, the availability is information indicating whether it is available for each electric vehicle 50 according to the charging plan. That is, the result of determining whether the power feeder 20 is available according to the task schedule of the electric vehicle 50 is indicated instead of the presence or absence of the operation of the power feeder 20 itself. For example, even in a time slot in which there is no reservation for use of the power feeder 20, charging cannot be performed during a time at which there is a work schedule in the electric vehicle 50.

Further, the reservation status display field 410 includes an arrow 412 indicating a start position of the band graph together with information indicating a recommended charging place (station name) and charging start time. The band graph includes an image element 416 indicating a time at which a charging reservation has already been made. Further, the time period during which the electric vehicle 50 is charged may be indicated on the band graph using an image element 414 of an image different from the image element 416.

The reservation information display field 420 is a display field indicating the reservation content of charging, and displays the vehicle ID, the charging type, the station name, and the charging start time of the electric vehicle 50. In the reservation information display field 420, a recommended charging schedule is displayed as an initial value. However, each item displayed in the reservation information display field 420 may be a user interface (UI) that receives input or selection of a text box or the like. In this case, the user may perform an input operation in the text box, and the information processing device 100 may accept the change of the reservation content of the user.

Alternatively, the position of the arrow 412 may be moved by the user performing drag operation on the touch panel. That is, the provision unit 106 may receive the moving operation of the arrow 412 of the user, and may receive the time of the station of the moving destination as the charging start time. Then, the provision unit 106 may display the changed reservation content in the reservation information display field 420.

In a case of receiving the press of the reservation confirmation button 430, the plan creation unit 104 determines whether the reservation is possible in a case where the reservation content is changed in the reservation information display field 420. That is, it is determined whether the reserved time of the power feeder 20 confirmed to be reserved is available. In a case where the reservation can be made, the provision unit 106 displays a message notifying that the reservation can be made, and in a case where the reservation can be completed, a message prompting pressing of the reservation completion button 432 is also displayed. In a case where there is no free time in the reservation time, the provision unit 106 displays a message indicating that there is no free time. Furthermore, the provision unit 106 may display a message indicating whether a proposal of another recommended charging schedule is desired and an operation button (not illustrated) for accepting the reproposal. In a case of receiving the pressing of the operation button for receiving the reproposal, the plan creation unit 104 may perform update processing of the charging plan.

However, instead of the reservation confirmation processing using the reservation confirmation button 430, the provision unit 106 may display a proposal for a changeable charging schedule on the reservation screen 400. As described above, since the change in the charging plan affects the other electric vehicles 50, a limit may be set to the change. For example, the plan creation unit 104 may prepare a plurality of candidates for the recommended charging schedule with priority for each electric vehicle 50, and propose the recommended charging schedule according to the priority.

The charging plan update processing method can be performed similarly to the fourth example embodiment described above. That is, the plan creation unit 104 first selects the power feeder 20 that does not include the charging schedule of another electric vehicle 50, and updates the charging plan of the electric vehicle 50. In a case where there is no power feeder 20 that does not include a charging schedule of another electric vehicle 50, the charging plan including the plurality of electric vehicles 50 is updated.

Upon receiving the press of the reservation completion button 432, the reservation content displayed in the reservation information display field 420 is completed, and the plan creation unit 104 stores the reservation content in the storage device 120 as a power feeder-specific power feeding reservation information 166. In a case of receiving the pressing of the return button 434, the provision unit 106 closes the reservation screen 400.

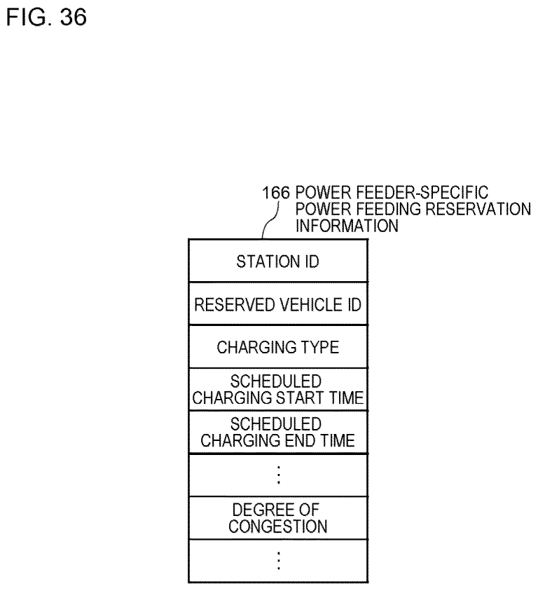

FIG. 36 is a diagram illustrating an example of a data structure of the power feeder-specific power feeding reservation information 166.

The power feeder-specific power feeding reservation information 166 includes a station ID for each power feeder 20, a vehicle ID of the electric vehicle 50 for which charging is reserved for each reservation, a charging type, a scheduled charging start time, and a scheduled charging end time. Furthermore, the power feeder-specific power feeding reservation information 166 may include information indicating the degree of congestion of the power feeder 20. Furthermore, the information indicating the degree of congestion may be the degree of congestion for each time slot or the degree of congestion in one day.

According to this configuration, the power feeder 20 can be reserved based on the charging schedule recommended based on the charging plan.

While a plurality of steps (processes) is described in order in the plurality of flowcharts used in the descriptions above, the execution order of the steps executed in each example embodiment is not limited to the described order. In each example embodiment, the order of the illustrated steps can be changed as long as there is no problem in terms of content. The above-described example embodiments can be combined within a range in which the contents not contradictory.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

In the present invention, in a case where information regarding the user is acquired and used, the information is lawfully performed.

Some or all of the example embodiments described above may be described as the following Supplementary Notes, but are not limited to the following.
1. An information processing device including:
a first model generated for each vehicle type of a plurality of electric vehicles used at an airport, the first model that receives, as an input, information including a work content of the electric vehicle and outputs a predicted power consumption of the electric vehicle;
acquisition means for acquiring a current task schedule including work content of each of the plurality of electric vehicles; and
plan creation means for inputting work contents specified based on the task schedules of the plurality of electric vehicles to the first models associated with vehicle types of the electric vehicles, and creating a charging plan of the plurality of electric vehicles using the output of the first models, the charging plan including information regarding a charging start timing and a power feeder for each of the electric vehicles.
2. The information processing device according to item 1, in which
the work content includes flight information on an airplane to be worked by the electric vehicle.
3. The information processing device according to item 2, in which
the flight information further includes information regarding an airline company that operates the airplane.
4. The information processing device according to any one of items 1 to 3, in which
the work content further includes a work start time and a work end time, and
the plan creation means creates the charging plan further using at least one of the work start time and the work end time associated with an output for each of the electric vehicles from the first model.
5. The information processing device according to any one of items 1 to 4, in which
the acquisition means and the plan creation means execute repetitive processing.
6. The information processing device according to any one of items 1 to 5, in which
the plan creation means
creates a charging plan using a second model that receives, as an input, the output of the first model and outputs the charging plan.
7. The information processing device according to any one of items 1 to 6, in which
the plan creation means further uses information related to a current remaining power amount of the electric vehicle in creating the charging plan.
8. The information processing device according to any one of items 1 to 7, in which
the work content further includes a work place for each of the electric vehicles, and
the plan creation means creates the charging plan further using the work place associated with the output for each of the electric vehicles from the first model.
9. A charging plan creating system including:
a user terminal of a user using a plurality of electric vehicles used at an airport;
an information processing device, wherein
the information processing device includes:
a first model generated for each vehicle type of a plurality of electric vehicles used at an airport, the first model that receives, as an input, information including a work content of the electric vehicle and outputs a predicted power consumption of the electric vehicle for each vehicle type of the plurality of electric vehicles;
acquisition means for acquiring a current task schedule including work content of each of the plurality of electric vehicles;
plan creation means for inputting work contents specified based on the task schedules of the plurality of electric vehicles to the first models associated with vehicle types of the electric vehicles, and creating a charging plan of the plurality of electric vehicles using the output of the first models, the charging plan including information regarding a charging start timing and a power feeder for each of the electric vehicles; and
provision means for providing information regarding the charging plan to the user terminal.
10. The charging plan creating system according to item 9, in which
the work content includes flight information on an airplane to be worked by the electric vehicle.
11. The charging plan creating system according to item 10, in which
the flight information further includes information regarding an airline company that operates the airplane.
12. The charging plan creating system according to any one of items 9 to 11, in which
the work content further includes a work start time and a work end time, and
the plan creation means of the information processing device creates the charging plan further using at least one of the work start time and the work end time associated with an output for each of the electric vehicles from the first model.
13. The charging plan creating system according to any one of items 9 to 12, in which
the acquisition means and the plan creation means of the information processing device execute repetitive processing.
14. The charging plan creating system according to any one of items 9 to 13, in which
the plan creation means of the information processing device
creates a charging plan using a second model that receives, as an input, the output of the first model and outputs the charging plan.
15. The charging plan creating system according to any one of items 9 to 14, in which
the plan creation means of the information processing device further uses information related to a current remaining power amount of the electric vehicle in creating the charging plan.
16. The charging plan creating system according to any one of items 9 to 15, in which
the work content further includes a work place for each of the electric vehicles, and
the plan creation means of the information processing device creates the charging plan further using the work place associated with the output for each of the electric vehicles from the first model.
17. An information processing method in which one or more computers include:
a first model generated for each vehicle type of a plurality of electric vehicles used at an airport, the first model that receives, as an input, information including a work content of the electric vehicle and outputs a predicted power consumption of the electric vehicle, wherein
the one or more computers
acquire a current task schedule including work content of each of the plurality of electric vehicles; and
input work contents specified based on the task schedules of the plurality of electric vehicles to the first models associated with vehicle types of the electric vehicles, and create a charging plan of the plurality of electric vehicles using the output of the first models, the charging plan including information regarding a charging start timing and a power feeder for each of the electric vehicles.
18. The information processing method according to item 17, in which
the work content includes flight information on an airplane to be worked by the electric vehicle.
19. The information processing method according to item 18, in which
the flight information further includes information regarding an airline company that operates the airplane.
20. The information processing method according to any one of items 17 to 19, in which
the work content further includes a work start time and a work end time, and
the one or more computers
create the charging plan further using at least one of the work start time and the work end time associated with an output for each of the electric vehicles from the first model.
21. The information processing method according to any one of items 17 to 20, in which
the one or more computers
execute repetitive processing of acquiring the task schedule and creating the charging plan.
22. The information processing method according to any one of items 17 to 21, in which
the one or more computers
create a charging plan using a second model that receives, as an input, the output of the first model and outputs the charging plan.
23. The information processing method according to any one of items 17 to 22, in which
the one or more computers
further use information related to a current remaining power amount of the electric vehicle in creating the charging plan.
24. The information processing method according to any one of items 17 to 23, in which
the work content further includes a work place for each of the electric vehicles, and
the one or more computers
create the charging plan further using the work place associated with the output for each of the electric vehicles from the first model.
25. A program in which a computer includes a first model generated for each vehicle type of a plurality of electric vehicles used at an airport, the first model that receives, as an input, information including a work content of the electric vehicle and outputs a predicted power consumption of the electric vehicle,
the program causing the computer to execute:
acquisition processing for acquiring a current task schedule including work content of each of the plurality of electric vehicles; and
plan creation processing for inputting work contents specified based on the task schedules of the plurality of electric vehicles to the first models associated with vehicle types of the electric vehicles, and creating a charging plan of the plurality of electric vehicles using the output of the first models, the charging plan including information regarding a charging start timing and a power feeder for each of the electric vehicles.
26. The program according to item 25, in which
the work content includes flight information on an airplane to be worked by the electric vehicle.
27. The program according to item 26, in which
the flight information further includes information regarding an airline company that operates the airplane.
28. The program according to any one of items 25 to 27, in which
the work content further includes a work start time and a work end time, and
the plan creation processing creates the charging plan further using at least one of the work start time and the work end time associated with an output for each of the electric vehicles from the first model.
29. The program according to any one of items 25 to 28, further causing the computer to execute
repetitive processing of the acquisition processing and the plan creation processing.
30. The program according to any one of items 25 to 29, in which
the plan creation processing
creates a charging plan using a second model that receives, as an input, the output of the first model and outputs the charging plan.
31. The program according to any one of items 25 to 30, in which
the plan creation processing further uses information related to a current remaining power amount of the electric vehicle in creating the charging plan.
32. The program according to any one of items 25 to 31, in which
the work content further includes a work place for each of the electric vehicles, and
the plan creation processing creates the charging plan further using the work place associated with the output for each of the electric vehicles from the first model.
33. A computer-readable recording medium recording a program, in which a computer includes
a first model generated for each vehicle type of a plurality of electric vehicles used at an airport, the first model that receives, as an input, information including a work content of the electric vehicle and outputs a predicted power consumption of the electric vehicle, for causing the computer to execute:
acquisition processing for acquiring a current task schedule including work content of each of the plurality of electric vehicles; and
plan creation processing for inputting work contents specified based on the task schedules of the plurality of electric vehicles to the first models associated with vehicle types of the electric vehicles, and creating a charging plan of the plurality of electric vehicles using the output of the first models, the charging plan including information regarding a charging start timing and a power feeder for each of the electric vehicles.
34. The computer-readable recording medium recording a program according to item 33, in which
the work content includes flight information on an airplane to be worked by the electric vehicle.
35. The computer-readable recording medium recording a program according to item 34, in which
the flight information further includes information regarding an airline company that operates the airplane.
36. The computer-readable recording medium recording a program according to items 33 to 35, in which
the work content further includes a work start time and a work end time, and
the plan creation processing creates the charging plan further using at least one of the work start time and the work end time associated with an output for each of the electric vehicles from the first model.
37. The computer-readable recording medium recording a program according to any one of items 33 to 36, further causing the computer to execute
repetitive processing of the acquisition processing and the plan creation processing.
38. The computer-readable recording medium recording a program according to any one of items 33 to 37, in which
the plan creation processing
further creates a charging plan by using a second model that receives, as an input, the output of the first model and outputs the charging plan in the plan creating processing.
39. The computer-readable recording medium recording a program according to any one of items 33 to 38, in which
the plan creation processing further uses information related to a current remaining power amount of the electric vehicle in creating the charging plan.
40. The computer-readable recording medium recording a program according to any one of items 33 to 39, in which
the work content further includes a work place for each of the electric vehicles, and
the plan creation processing creates the charging plan further using the work place associated with the output for each of the electric vehicles from the first model.

This application is based upon and claims the benefit of priority from Japanese Patent Application No. 2023-059160, filed on Mar. 31, 2023, the disclosure of which is incorporated herein in its entirety by reference.

### REFERENCE SIGNS LIST

1 charging plan creating system
3 communication network
5, 5a, 5b camera
20, 20a, 20b power feeder
50, 50a, 50b electric vehicle
100 information processing device
102 acquisition unit
104 plan creation unit
106 provision unit
112 model generation unit
120 storage device
122, 122a, 122b prediction model
124 optimization model
130 vehicle information
132 vehicle battery information
134 vehicle-specific charging history information
140 work schedule information
142 parameter information
144 power consumption prediction information
146 vehicle-specific work situation information
150 flight information
152 aircraft information
160 power feeder information
162 power feeder-specific power feeding history information
164 power feeder usage prediction information
166 power feeder-specific power feeding reservation information
170 recommendation information
180 user information
200, 200a, 200b user terminal
300 notification screen
310 predicted usage status screen
320 predicted usage status screen
330 predicted usage status detail screen
340 predicted usage status screen
350 charging plan screen
400 reservation screen
1000 computer
1010 bus
1020 processor
1030 memory
1040 storage device
1050 input/output interface
1060 network interface

What is claimed is:

1. An information processing apparatus comprising:
a first model generated for each vehicle type of a plurality of electric vehicles used at an airport, the first model that receives, as an input, information comprising a work content of the electric vehicle and outputs a predicted power consumption of the electric vehicle;
at least one memory storing instructions; and
at least one processor configured to execute the instructions to:
acquire a current task schedule comprising work content of each of the plurality of electric vehicles; and
input work contents specified based on the task schedules of the plurality of electric vehicles to the first models associated with vehicle types of the electric vehicles, and create a charging plan of the plurality of electric vehicles using the output of the first models, the charging plan comprising information regarding a charging start timing and a power feeder for each of the electric vehicles.

2. The information processing apparatus according to claim 1, wherein
the work content comprises flight information on an airplane to be worked by the electric vehicle.

3. The information processing apparatus according to claim 1, wherein
the work content further comprises a work start time and a work end time, and
the at least one processor is further configured to execute the instructions to create the charging plan further using at least one of the work start time and the work end time associated with an output for each of the electric vehicles from the first model.

4. The information processing apparatus according to claim 1, wherein
the at least one processor is further configured to execute the instructions to execute repetitive processing of acquiring the task schedule and creating the charging plan.

5. The information processing apparatus according to claim 1, wherein
the at least one processor is further configured to execute the instructions to create a charging plan using a second model that receives, as an input, the output of the first model and outputs the charging plan.

6. The information processing apparatus according to claim 1, wherein
the at least one processor is further configured to execute the instructions to further use information related to a current remaining power amount of the electric vehicle in creating the charging plan.

7. The information processing apparatus according to claim 1, wherein
the work content further comprises a work place for each of the electric vehicles, and
the at least one processor is further configured to execute the instructions to create the charging plan further using the work place associated with the output for each of the electric vehicles from the first model.

8. The information processing apparatus according to claim 2, wherein
the flight information further comprises information regarding an airline company that operates the airplane.

9. (canceled)

10. An information processing method in which one or more computers comprise:
a first model generated for each vehicle type of a plurality of electric vehicles used at an airport, the first model that receives, as an input, information comprising a work content of the electric vehicle and outputs a predicted power consumption of the electric vehicle, wherein the information processing method comprises, by the one or more computers:
acquiring a current task schedule comprising work content of each of the plurality of electric vehicles; and
inputting work contents specified based on the task schedules of the plurality of electric vehicles to the first models associated with vehicle types of the electric vehicles, and creating a charging plan of the plurality of electric vehicles using the output of the first models, the charging plan comprising information regarding a charging start timing and a power feeder for each of the electric vehicles.

11. The information processing method according to claim 10, wherein
the work content comprises flight information on an airplane to be worked by the electric vehicle.

12. The information processing method according to claim 10, wherein
the work content further comprises a work start time and a work end time, and
the information processing method comprises, by the one or more computers,
creating the charging plan further using at least one of the work start time and the work end time associated with an output for each of the electric vehicles from the first model.

13. The information processing method according to claim 10, comprising, by the one or more computers,
executing repeatedly acquiring the task schedule and creating the charging plan.

14. The information processing method according to claim 10, comprising, by the one or more computers,
creating a charging plan using a second model that receives, as an input, the output of the first model and outputs the charging plan.

15. The information processing method according to claim 10, comprising, by the one or more computers,
further using information related to a current remaining power amount of the electric vehicle in creating the charging plan.

16. A non-transitory computer-readable recording medium storing a program for causing a computer comprising a first model generated for each vehicle type of a plurality of electric vehicles used at an airport, the first model that receives, as an input, information comprising a work content of the electric vehicle and outputs a predicted power consumption of the electric vehicle to execute:
acquisition processing for acquiring a current task schedule comprising work content of each of the plurality of electric vehicles; and
plan creation processing for inputting work contents specified based on the task schedules of the plurality of electric vehicles to the first models associated with vehicle types of the electric vehicles, and creating a charging plan of the plurality of electric vehicles using the output of the first models, the charging plan comprising information regarding a charging start timing and a power feeder for each of the electric vehicles.

17. The non-transitory computer-readable recording medium storing a program according to claim 16, wherein
the work content comprises flight information on an airplane to be worked by the electric vehicle.

18. The non-transitory computer-readable recording medium storing a program according to claim 16, wherein
the work content further comprises a work start time and a work end time, and
the plan creation processing creates the charging plan further using at least one of the work start time and the work end time associated with an output for each of the electric vehicles from the first model.

19. The non-transitory computer-readable recording medium storing a program according to claim 16, further causing the computer to execute
repetitive processing of the acquisition processing and the plan creation processing.

20. The non-transitory computer-readable recording medium storing a program according to claim 16, causing the computer to
create a charging plan by using a second model that receives, as an input, the output of the first model and outputs the charging plan in the plan creation processing.
